(19) United States
(12) Patent Application Publication
(10) Pub. No.: US 2026/0099502 A1
(43) Pub. Date: Apr. 9, 2026

(54) MAINTAINING PRIVACY AND DATA SECURITY IN DETERMINATIONS RELATED TO SPECIFIC USERS USING AGGREGATED ATTRIBUTES

(71) Applicant: TRANS UNION LLC, Chicago, IL (US)

(72) Inventor: Colin DEW-BECKER, Chicago, IL (US)

(73) Assignee: TRANS UNION LLC, Chicago, IL (US)

(21) Appl. No.: 19/337,417

(22) Filed: Sep. 23, 2025

Related U.S. Application Data
(60) Provisional application No. 63/704,911, filed on Oct. 8, 2024.

(51) Int. Cl. G06F 16/248; G06F 16/215; G06F 16/2458

(52) U.S. Cl. CPC G06F 16/248; G06F 16/215; G06F 16/2462

(57) ABSTRACT

Aggregated attributes useful for informing determinations regarding a user identifier are computed based on a noisy identifier and selected data in a data store. The noisy identifier identifies a unique individual or entity represented in the data store with between about 75% confidence and about 90% confidence, for example. The aggregated attributes can aid in analyzing user behavior without using specifically-identifying information. Security of the specifically-identifying information and privacy of the individual or entity is thus maintained. A list of record change numbers is calculated for user identifiers associated with the noisy identifier. The aggregated attributes are calculated from the list for each user identifier, and the aggregated attributes for a selected user identifier, or a value or flag based thereon, are included in a report for the selected user identifier. The aggregated attributes can be processed by a model, e.g., a machine-learning model, to output the value or flag.

### CROSS-REFERENCE TO RELATED APPLICATION

This application claims the benefit of U.S. provisional application No. 63/704,911, filed Oct. 8, 2024, the content of which is incorporated herein by reference in its entirety.

### BACKGROUND

Data describing or memorializing details of user activities and behaviors can be stored as records in a data store, such as a database. In existing systems, in order to make a determination specific to a given user, the data for a particular user can be accessed for evaluation by querying the data store for an identifier, such as a user identifier particular to the data store, that is known to unambiguously identify the user. The user identifier can thus can be used in a query to select and retrieve records related to the user with full confidence that the records in fact relate to the user. In such systems, personally identifying information about the specific user may be transferred from a data owner to a third party.

### SUMMARY

Provided herein are system, apparatus, device, method and/or computer program product embodiments, and/or combinations and sub-combinations thereof, for a novel approach to computation of aggregated attribute data based on a noisy identifier and selected records in a data store. The data store can hold report data including dated reports. The report data can include a number of records, each of which is associated with a specific individual or entity (also referred to as a user). Whereas user identifiers each uniquely identify a corresponding individual or entity represented in the data store with full confidence, the noisy identifier identifies a unique individual or entity represented in the data store with less than full confidence, e.g., less than about ninety percent confidence. Thus, for example, a noisy identifier may be associated with a plurality of different user identifiers in the data store. User identifiers associated with the noisy identifier in the data store are fetched from the data store. A list of user identifiers and associated counts of records are compiled, and aggregated attributes can be calculated based on the compilation of counts of records.

The counts of records compilation can happen as follows. For each user identifier of the user identifiers associated with the noisy identifier, a first number of records matching one or more specified attribute criteria and associated with a first dated report associated with the user identifier are counted. The first dated report is of a first date.

Also for each user identifier of the user identifiers, a second number of records matching the one or more specified attribute criteria and associated with a second dated report associated with the user identifier are counted. The second dated report is of a second date earlier than the first date.

For each user identifier of the user identifiers, a record change number for the user identifier is calculated by subtracting the second number of records from the first number of records. For each user identifier of the user identifiers, the user identifier and its associated record change number can be removed from the list based on the record change number being less than a threshold value or outside a threshold range (e.g., based on the record change number equaling zero).

Statistical attributes are then calculated as aggregated attributes for each user identifier of the user identifiers associated with the noisy identifier, based on the record change numbers in the list. This process can be repeated for a number of different noisy identifiers, e.g., until all of the user identifiers represented in the data store have had aggregated attributes calculated for them. The aggregated attributes for any given user identifier can be stored in the data store or another data store, transmitted to a client device, and/or used to make a user-related determination. For example, report for a selected one of the user identifiers can be modified to include the calculated aggregated attributes for the selected user identifier, or to include a value or flag derived from the calculated aggregated attributes for the selected user identifier. The modified report can be transmitted to a client device that is restricted from receiving ones of the record change numbers that are specific to the selected user identifier. In some examples, a machine-learning model can further be used, with the aggregated attributes provided as inputs to the model, to aid in making the user-related determination. Because the aggregated attributes and any user-related determination based thereon are based on the noisy identifier and not solely on the specific user identifier, privacy and security benefits, among other advantages, are gained using the system, apparatus, device, method and/or computer program product embodiments described herein.

### BRIEF DESCRIPTION OF THE DRAWINGS

The accompanying drawings are incorporated herein and form a part of the specification.

FIG. 1 is a block diagram of an example data environment using aggregated attribute data for user-related determinations, according to some aspects of this disclosure.

FIG. 2 is a sequence diagram of an example method for user-related determinations based on aggregated attribute data, according to some aspects of this disclosure.

FIG. 3 is a flowchart of an example method for computation of aggregated attribute data useful for user-related determinations, according to some aspects of this disclosure.

FIGS. 4A through 4E are flowcharts of an example method for computation of aggregated attribute data for credit determinations to address tradeline washing, according to some aspects of this disclosure.

FIGS. 5A through 5E are flowcharts of another example method for computation of aggregated attribute data for credit determinations to address inquiry washing, according to some aspects of this disclosure.

FIG. 6 is a block diagram of an example device including a user-related determination machine-learning model trained to output user-related determinations based on input aggregated attributes, such as those calculated using the methods of FIGS. 3, 4A through 4E, or 5A through 5E.

FIG. 7 is an example of a computer system useful for implementing various aspects of this disclosure.

In the drawings, like reference numbers generally indicate identical or similar elements. Additionally, generally, the leftmost digit(s) of a reference number identifies the drawing in which the reference number first appears.

### DETAILED DESCRIPTION

Provided herein are system, apparatus, device, method and/or computer program product embodiments, and/or combinations and sub-combinations thereof, for making determinations related to a specific user based on a noisy identifier and aggregated attribute data. A noisy identifier is an identifier that identifies a particular entity, such as a user (a person or a business enterprise, as examples), with less than full confidence, e.g., less than about 90% confidence. A noisy identifier thus may also incidentally identify entities (e.g., users) other than the particular entity. For example, a search query of a data store that uses the noisy identifier to search the data store for the particular entity may return records related to the particular entity and records related to other entities that may also be associated with the noisy identifier.

Attribute data is data that relates to attributes of one or more entities. The attribute data may reveal activities, behavior, or preferences of the one or more entities, e.g., through analysis or processing of the attribute data, e.g., using statistical methods or a machine learning model. Attribute data may be used to make determinations related to an entity (e.g., user), such as whether to extend an offer of credit to a user or include the user in a targeted campaign. Aggregated attribute data is attribute data computed or compiled for an entity (e.g., user) identified by using a noisy identifier. The aggregated attribute data thus may be based not only on records related to the particular entity but also on records related to other entities identified by the noisy identifier. Because the aggregated attribute data is aggregated from multiple entities, it can provide technical benefits and advantages related to privacy and security. Although stored aggregated attribute data may be associated with a unique user identifier in a data store, for example, the aggregated attribute data, in itself, is not necessarily traceable to a particular user, and does not necessarily reflect the activities, behavior, or preferences of the particular user. The use of a noisy identifier and aggregated attribute data can thus have the technical benefit of providing enhanced privacy and security in making determinations based on stored data related to user activities, behaviors, and/or preferences.

In an example where a server includes user-specific data, a user identifier may be provided from a client device to the server via an application programming interface (API). The server may identify a noisy identifier corresponding to the user identifier and return aggregated attribute data that has been identified by the server using the noisy identifier. In this way, user-specific data is securely maintained on the server and is not transmitted to the client device, while useful data that can be used by the client device is still provided by the server. In another example where a client device includes user-specific data, the client device may itself identify a noisy identifier corresponding to a user identifier and transmit the noisy identifier to the server via an API, such that the server returns aggregated attribute data that has been identified using the noisy identifier. In this way, user-specific data is securely maintained on the client device and not transmitted to the server, while the server is still able to provide useful data to the client device. Some aspects also prevent systematic bias by removing certain user-specific data from determinations about that user, and instead applying aggregated attribute data that allows the user to maintain some anonymity.

Implementations for requesting, computing, and delivering the aggregated attribute data are described herein. Implementations for applying the aggregated attribute data to a model, such as a machine learning model, to output an indicator or score that can, for example, warn of a user-related activity condition are also described. For example, implementations using a noisy identifier and aggregated attributes as described herein may advantageously be capable of detecting potential fraud or other undesirable behaviors, information about which can be used when making relevant determinations, without exposing attributes of a particular user or making the determination based on attributes of a particular user.

The aggregated attributes generated by described embodiments can include calculated sums, averages, minimums, and maximums of temporal changes in records aggregated on the noisy identifier. The aggregated attributes can be provided to a model, such as a scoring model, which can be returned (e.g., as a alert or as part of a score) on a report, and in various batch processes or other real-time data feeds accessible, for example, via an application programming interface (API).

### Data Environment and Communication Sequence

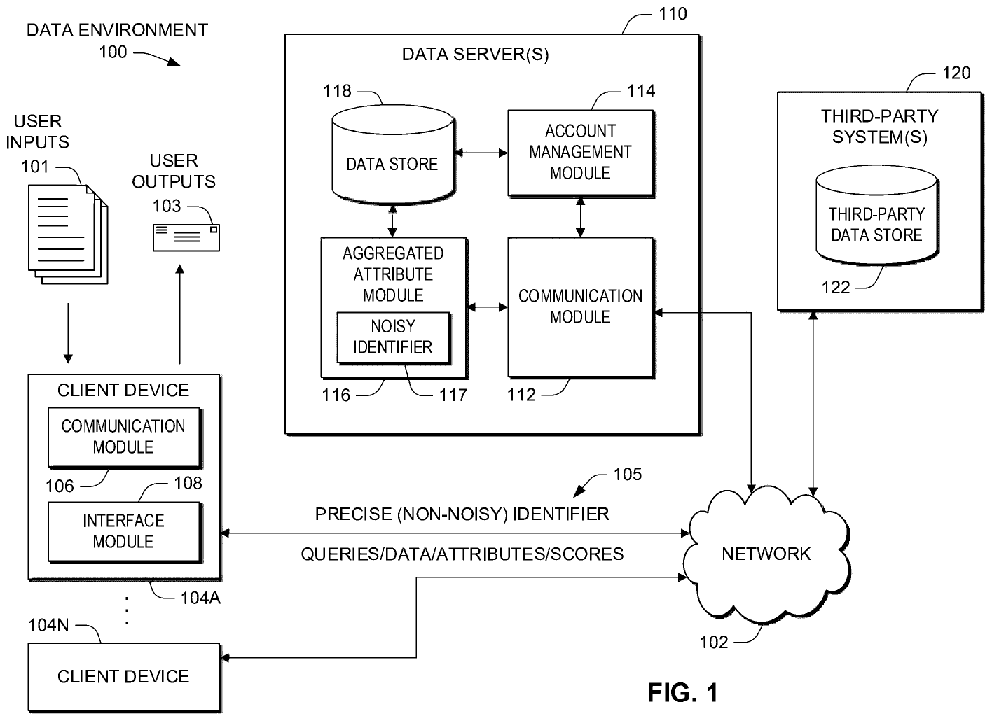

FIG. 1 shows a block diagram of an example data environment 100 using aggregated attribute data for determinations related to specific users. A “user” as used herein refers to a customer or other individual whose personal information is maintained in one or more locations of data environment 110. Data environment 100 is an example of one suitable system environment and is not intended to suggest any limitation as to the scope of use or functionality of aspects described herein. Neither should the data environment 100 be interpreted as having any dependency or requirement related to any single device/module/component or combination of devices/modules/components described therein.

According to some aspects of this disclosure, data environment 100 may include a network 102. According to some aspects of this disclosure, network 102 may include a packet-switched network (e.g., internet protocol-based network), a non-packet-switched network (e.g., quadrature amplitude modulation-based network), and/or the like. According to some aspects of this disclosure, network 102 may include network adapters, switches, routers, modems, and the like connected through wireless links (e.g., radio frequency, optical satellite) and/or physical links (e.g., fiber optic cable, coaxial cable, Ethernet cable, or a combination thereof). Network 102 may include public networks, private networks, wide area networks (e.g., the internet), local area networks, and/or the like. According to some aspects of this disclosure, network 102 can include a content access network, a content distribution network, and/or the like. According to some aspects of this disclosure, network 102 can provide and/or support communication from telephone, cellular, modem, fiber-optic, and/or other electronic devices to and throughout the data environment 100. For example, data environment 100 can include and support communications between one or more client devices, such as client devices 104A through 104N, one or more data servers 110, and/or one or more third-party systems 120 via network 102.

According to some aspects of this disclosure, a client device, such as any of client devices 104A through 104N, may be part of an entity-controlled domain, infrastructure, computing platform, and/or data environment. According to some aspects of this disclosure, a client device, such as any of client devices 104A through 104N, may represent a plurality of user devices in communication and/or interoperability within an entity-controlled domain, infrastructure, computing platform, and/or data environment. Data environment 100 may include any number of such client devices. Data environment 100 may also include any number of such entity-controlled domains which contain client devices different from client devices 104A through 104N. Where client device 104A is referred to below, the accompanying description is applicable to any of client devices 104A through 104N. Similarly, where data server 110 or third-party system 120 are referred to below, the accompanying description is applicable to any of the one or more data servers 110 or to any of the one or more third-party systems, 120, respectively.

According to some aspects of this disclosure, client device 104A can include, as examples, a smart device (e.g., a smart phone), a mobile device, a laptop, a tablet, a display device, a computing device, a server, or any other device capable of communicating with network 102, the one or more data servers 110, the one or more third-party systems 120, and/or any other device/component of data environment 100, either described or unshown. Client device 104A may include communication module 106 that facilitates and/or enables communication with network 102 (e.g., devices, components, and/or systems of network 102, etc.), data server 110, and/or any other device/component of data environment 100. For example, communication module 106 may include hardware and/or software to facilitate communication. According to some aspects of this disclosure, communication module 106 may include one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. According to some aspects of this disclosure, communication module 106 may include any hardware and/or software necessary to facilitate communication.

According to some aspects of this disclosure, client device 104A may include an interface module 108 configured to enable an operator of client device 104A to interact with client device 104A, network 102, data server 110, third-party system 120, and/or any other device/component of data environment 100. According to some aspects of this disclosure, interface module 108 may include one or more input devices and/or components, for example, a keyboard, a pointing device (e.g., a computer mouse, remote control), a microphone, a joystick, a tactile input device (e.g., touch screen, gloves, etc.), and/or the like. Interaction with the input devices and/or components may enable an operator to interact with a user interface generated and/or displayed by the interface module 108 and/or the like.

According to some aspects of this disclosure, client device 104A can present to an operator, and/or receive from an operator, information or information requests. In some examples, the information or information requests can include credit queries, credit data, credit attributes, credit scores, and/or synthetic fraud scores. The credit data can include, as examples, historical transaction or pattern data, credit reputation data, digital identity-related data, and/or behavioral or usage data. For example, client device 104A can include software, such as a web browser or a dedicated application (e.g., a mobile device application). Client device 104A can be configured to facilitate the exchange of information and/or information requests between client device 104A and data server 110 and/or between client device 104A and third-party system 120 while maintaining compliance with data protection restrictions. Client device 104A may request or query data (e.g., data values or data files) from a local source (e.g., a data storage module (not shown) in client device 104A) and/or a remote source, such as data store 118 in data server 110, third-party data store 122 in third-party system 120, and/or any other device/component of data environment 100. For example, interaction with input devices and/or components of interface module 108 may enable requests to be sent to data server 110 for generation and/or retrieval of attribute data that is aggregated and therefore not particularly identifiable or traceable to any single particular entity, e.g., not particularly identifiable or traceable to any single credit applicant or credit offer target. In some aspects, a particular entity can be analyzed and/or evaluated by client device 104A or data server 110 using a combination of identifiable attribute data and non-identifiable attribute data.

Client device 104A may process data inputs and/or data outputs containing personally identifiable information (PII) of a user, such as a credit applicant or credit offer target. As an example, client device 104A can be configured to receive data inputs from user inputs 101 (e.g., a credit application submitted by a credit applicant). As another example, client device 104A can be configured to produce or generate user outputs 103 (e.g., a credit offer). In some examples, a different one of the client devices 104A through 104N generates the user outputs 103 from that which receives the user inputs 101. For example, a first client device 104A may receive a user input 101, and transmit an information request (e.g., a credit query), based on data in the user input 101, to one or more data servers 110, and a second client device 104N may subsequently receive data, attributes, or a score (e.g., a credit score, a synthetic fraud score, credit attributes, and/or other credit data) from the one or more data servers 110, responsive to the transmitted information request. The second client device 104N may then generate and/or transmit a user output 103 (e.g., a credit offer) based on the received data, attributes, or score.

User inputs 101 can be received by client device 104A in a number of ways. As one example, a credit applicant may supply credit-related data, including PII, in a paper credit application and submit the paper credit application as user inputs 101 to a human or automated agent of an enterprise organization (e.g., a lender or credit card issuer) to enter credit data from the paper credit application into client device 104A, e.g., via a user interface generated and managed by interface module 108. As another example, a credit applicant may supply credit data as user inputs 101 into an electronic form, such as a web form or a form in a dedicated software application (e.g., a mobile device application), and, upon submitting the web form, the credit data is automatically provided to client device 104A. As yet another example, a credit application may be submitted as user inputs 101 via electronic message, such as email or text message. As still other examples, a credit applicant may orally provide credit information to the human or automated agent to enter into the client device 104A, e.g., either in-person, or over a telephone, teleconference, or videoconference conversation, and the human or automated agent may subsequently enter the orally provided information as user inputs 101. In yet other examples, no credit application is provided by a credit applicant, and instead, client device 104A obtains credit data, such as PII, about a credit offer target, and submits the obtained credit data to one or more of the credit data servers 110 to request a credit score, credit attributes, and/or other credit data responsive to the credit query submitted by the client device 104A. For example, client device 104A may obtain information about potential credit offer targets from one or more third-party systems 120 (which may or may not be part of the same enterprise organization as client device 104A), and may filter the obtained information to extend credit offers as user outputs 103 to selected ones of the potential credit offer targets using credit scores, credit attributes, and/or other credit data received from one or more data servers 110. In some aspects, one or more data servers 110 are associated with a credit bureau. The credit application and/or credit offer may be for a personal or business line of credit, a real property mortgage, a credit card, or a secured or unsecured loan, to name but a few examples.

Client device 104A may generate user outputs 103 and extend one or more credit offers in a number of ways. In some examples, client device 104A may generate a credit offer as user output 103 responsive to a credit application provided as user inputs 101. User output 103 may take the form of a paper mail communication, an electronic communication (e.g., an email, a text message, or a mobile device application alert), or an oral communication (e.g., delivered by a human or automated agent of the enterprise organization in control of client device 104A in person or by telephone, teleconference, or video conference call). In some examples, user outputs 103 may take the form of a direct marketing campaign, with offers sent only to pre-approved or pre-selected offer targets (e.g., credit offer targets) based on credit scores, credit attributes, and/or other credit data provided to client device 104A from one or more data servers 110. Thus, in some examples, client device 104A can generate lists of credit offer targets (e.g., names and addresses, e-mail addresses, and/or phone numbers) and the lists can subsequently be used, by client device 104A or another device, in generating communications such as credit offers supplied as user outputs 103 to the listed credit offer targets. In other examples, user outputs 103 of client device 104A are not credit offers, but instead are one or more communications informing one or more credit applicants of credit approval or disapproval. In still other examples, user outputs 103 are other types of offers, denials, or other communications.

Third-party system 120 may include, access, support, and/or host any applications and/or data through any delivery paradigm, including but not limited to remote or distributed cloud computing solutions, local or on-premises software (“on-premises” cloud-based solutions), cloud-based services, “as a service” models (e.g., content as a service (CaaS), digital content as a service (DCaaS), software as a service (SaaS), managed software as a service (MSaaS), platform as a service (PaaS), backend as a service (BaaS), mobile backend as a service (MBaaS), infrastructure as a service (IaaS), etc.), and/or the like. Third-party system 120 may include and/or support systems including, but not limited to, commercial entities (e.g., merchant devices, e-commerce platforms, etc.), financial institutions and/or finance-supporting institutions (e.g., banks, credit card companies, government agencies, etc.), and/or the like that interact with client device 104A.

According to some aspects of this disclosure, the one or more data servers 110 may include a server, a cloud-based computing resource, or any other device capable of communicating with client device 104A, third-party system 120, and/or any other device/component of data environment 100, either described or (un)shown. Although shown as a single device, according to some aspects of this disclosure, the one or more data servers 110 may be part of a computing system and/or infrastructure, and/or may represent a plurality of computing devices. For example, the one or more data servers 110 may represent a plurality of computing devices in communication with client device 104A, third-party system 120, and/or any other device/component of data environment 100. For example, illustrated components of the one or more data servers 110, including account management module 114, aggregated attribute module 116, and data store 118 can all be included on a single server or can be distributed amongst multiple servers of the one or more data servers 110. Although the one or more data servers 110 may include multiple servers, for the sake of simplicity, they may be referred to below in the singular as data server 110.

The separation of client device 104A from data server 110 within data environment 100 can provide data protection advantages. As examples, client device 104A can be configured to store and process sensitive user data (e.g., consumer credit data) not accessible by data server 110, and, similarly, data server 110 can be configured to transmit to client device 104A only data or determination information that client device 104A is authorized to receive. Accordingly, data server 110 may store sensitive data (e.g., credit data), and/or may produce synthesized outputs based on its stored sensitive data, that remains securely inaccessible to client device 104A except by arranged permissions. For example, data server 110 may contain, access, and/or process sensitive data pertaining to millions or billions of individuals or entities, but client device 104A may be able to access only a select subset of that sensitive data, or, in some examples, may be able to access only synthesized outputs of the sensitive data accessible by data server 110, the synthesized outputs being generated by the data server 110 and transmitted to client device 104A via network 102, e.g., without client device 104A receiving any of the raw and potentially sensitive data stored in the data store 118 of the data server 110. For example, client device 104A may be able to access only synthesized outputs of data server 110, wherein the synthesized outputs include or are based on aggregated attribute data compiled or computed using a noisy identifier.

Client device 104A and credit data server 110 may be controlled by different entities. For example, client device 104A may be controlled by a lender, and data server 110 may be controlled by a credit bureau. The separation of third-party system 120 from client device 104A and data server 110 within data environment 100 can likewise provide data protection advantages. For example, third-party system 120 may be configured to provide select tradeline data and/or inquiry data to credit data server 110. Third-party system 120 and credit data server 110 may be controlled by different entities. In some aspects, third-party system 120 is controlled by a third-party credit card servicer or lender. In some examples, third-party system 120 may be restricted from accessing or receiving any or all data in data store 118 of data server 110. In some examples, client device 104A may be restricted from accessing or receiving any or all of data stored in third-party data store 122. The separation of client device 104A from third-party system 120 within data environment 100, and the separation of third-party system 120 from data server 110, can thus also provide data protection advantages.

According to some aspects of this disclosure, data server 110 may include communication module 112 that facilitates and/or enables communication with network 102 (e.g., devices, components, and/or systems of network 102, etc.), client device 104A, third-party system 120, and/or any other device/component of credit data environment 100. For example, communication module 112 may include hardware and/or software to facilitate communication. According to some aspects of this disclosure, communication module 112 may include one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. According to some aspects of this disclosure, communication module 112 may include any hardware and/or software necessary to facilitate communication.

According to some aspects of this disclosure, to facilitate computation of aggregated attribute data for determinations related to a specific user, data server 110 may include an aggregated attribute module 116. Aggregated attribute module 116 may include any interface for communicating information, such as aggregated attribute data, to/from client device 104A, etc., e.g., via communication module 112 and network 102. For example, aggregated attribute module 116 may include software, such as an application and/or the like configured with data server 110. Aggregated attribute module 116 may be a portion of an application architecture (e.g., a client-server model, etc.) that enables data server 110 to compute aggregated attributes and/or information or outputs based thereon for sending to client device 104A, by which client device 104A or a human or automated user thereof can make determinations related to a specific user, such as credit offer determinations. Aggregated attribute module 116 and client device 104A may be controlled by different entities (e.g., different enterprise organizations).

Aggregated attribute module 116 may request or query data and/or files from a local source, such as data store 118, and/or a remote source, such as third-party data store 122 of third-party system 120, and any other device/component of credit data environment 100. For example, data store 118 may store credit data, digital identity-related data, health-related data, financial data, etc., as may be received from user inputs 101 (e.g., credit applications) and/or third-party data store 122, and/or aggregated data computed by aggregated attribute module 116.

As one example, data store 118 may store a table of information about users, which are sometimes referred to as parties, and which can represent users of credit, credit applicants, and/or credit offer targets. The users table can include a column or field for a user identifier, which can be a unique numeric or alphanumeric value that uniquely identifies a single person or entity in the users table. The users table can include one or more columns or fields for names, such as full name, first name, last name, middle name, second middle name, etc. The users table can include one or more columns or fields for residential address, such as address number, street, city, state, country, county, Zone Improvement Plan (ZIP) code, etc. The users table can include a column or field for date of birth of the user. The users table can include a column or field for gender of the user. The users table can include one or more columns or fields for a Social Security number (SSN) associated with the user. For example, the users table might include a column or field for a primary SSN and other columns or fields for additional SSNs. SSNs may also be associated with the user in other ways than being stored in the users table. In some examples, SSNs are associated with the user by being associated with a different user who is a joint user or co-borrower on an account associated with the user, or who is an authorized user of an account associated with the user. An authorized user is a person who has been granted access to use another user's account, e.g., a credit card account, without being liable for the account. The users table can include various other fields containing information regarding the user, or as may be useful to link the user to other data tables in data store 118.

As another example, data store 118 may store a table of information about tradelines. A tradeline is a record of credit activity and/or account for a particular user. The tradelines table may include a column or field for a unique user identifier that can correspond to the unique user identifier column or field of the above-described users table. The tradelines table may further include a column or field for an account number. The tradelines table may further include a column or field for a date. The tradelines table may further include a column or field for an account rating profile code. Example account rating profile codes can include “G” to signify that the account is in collection, “H” to signify that the account is in foreclosure, “J” to signify that the account is in voluntary surrender, “K” to signify that the account is in repossession, and “L” to signify that the account is in charge-off. The tradelines table may further include columns or fields for a manner of payment code, a rating remark code, and/or payment pattern text. The tradelines table can include various other fields containing information regarding the user, or as may be useful to link the user to other data tables in data store 118.

As another example, data store 118 may store a table of information about inquiries, e.g., hard inquiries. An inquiry is a request to review a user's credit file and/or receive information about a user's credit file. When made by a lender, as opposed to by the user, an inquiry is known as a hard inquiry. Hard inquiry data that is returned on a user's credit report comes can be stored in the data store 118, for example, as monthly data archives. The inquiries table may include a column or field for a unique user identifier that can correspond to the unique user identifier column or field of the above-described users table. The inquiries table may further include a column or field for a date. The inquiries table may further include a column or field for an account type code. Example account type codes can include “AL” for auto lease, “AU” for automobile, “CC” for credit card, “CV” for conventional real estate mortgage, “DC” for debit card, “LC” for line of credit, “LN” for construction loan, “MD” for medical debt, “SM” for second mortgage, and “ST” for student loan. The inquiries table may further include a column or field for a kind-of-business (KOB) code. Example KOB codes can include “A” for automotive, “B” for banks and savings and loan institutions, “C” for clothing, “F” for personal finance, “L” for lumber, building material, and hardware, “N” for credit card and travel or entertainment companies, “Q” for credit unions and finance companies other than personal finance companies, “U” for utilities and fuel, and “Z” for miscellaneous. The inquiries table may further include a column or field for a portfolio type code. Example portfolio type codes can include “O” for open account (30, 60, or 90 days), “R” for revolving or option, “I” for installment, “M” for mortgage, and “C” for check credit (line of credit). The inquiries table can include various other fields containing information regarding the user, or as may be useful to link the user to other data tables in data store 118.

In some examples, user data, tradelines data, and/or inquiries data may each be stored in multiple different tables. In such examples, searching for user data, searching for tradelines data, and/or searching for inquiries data may include searching multiple different tables. In some examples, third-party data store 122 may store tables of the types described above. Searches can be conducted of third-party data store 122, in addition to data store 118, in such examples.

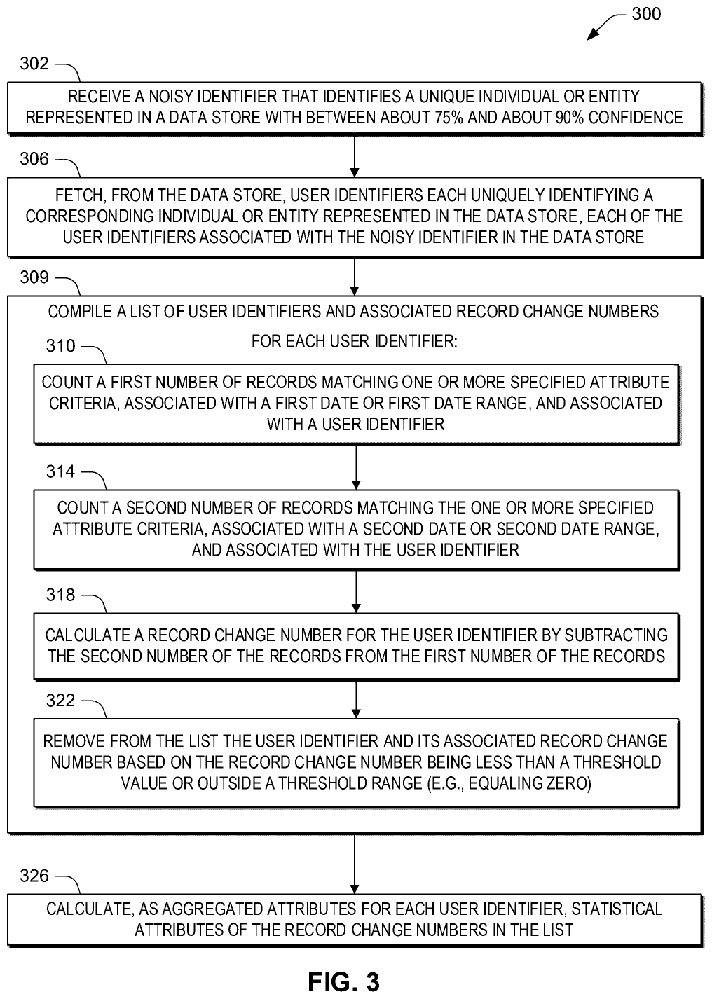

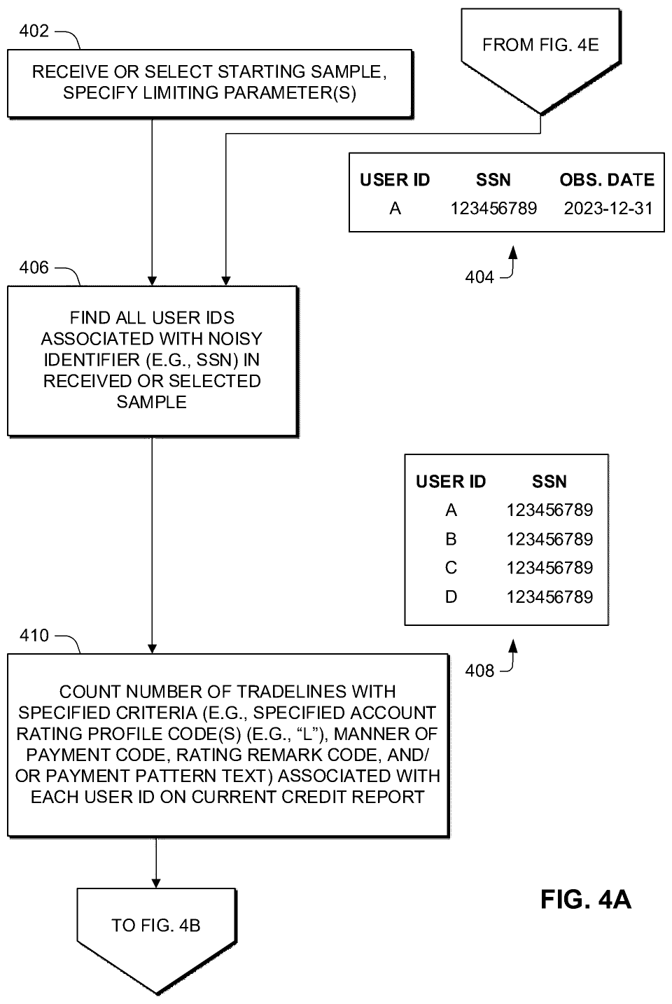

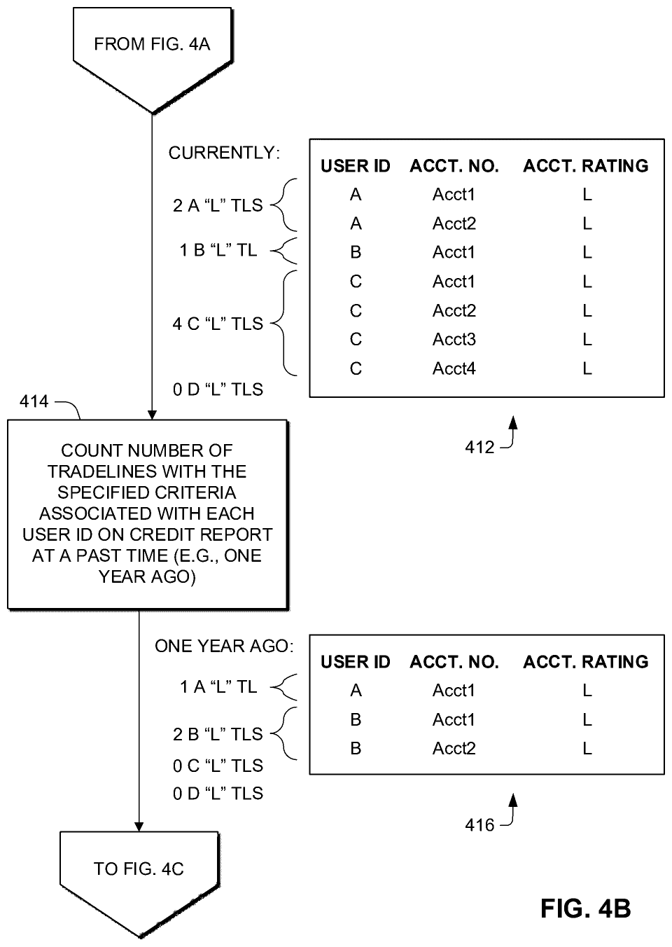

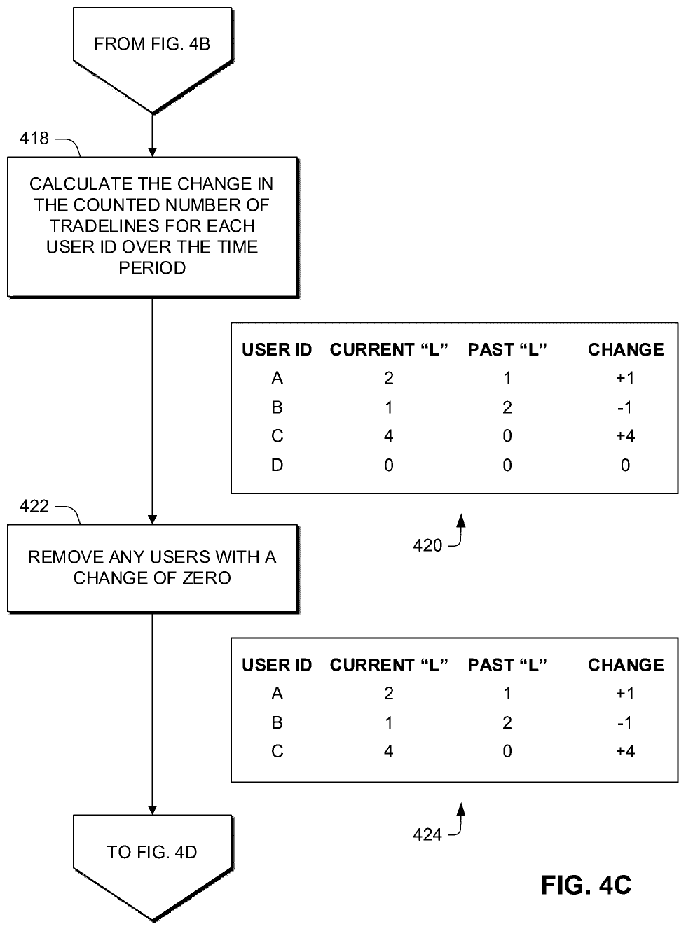

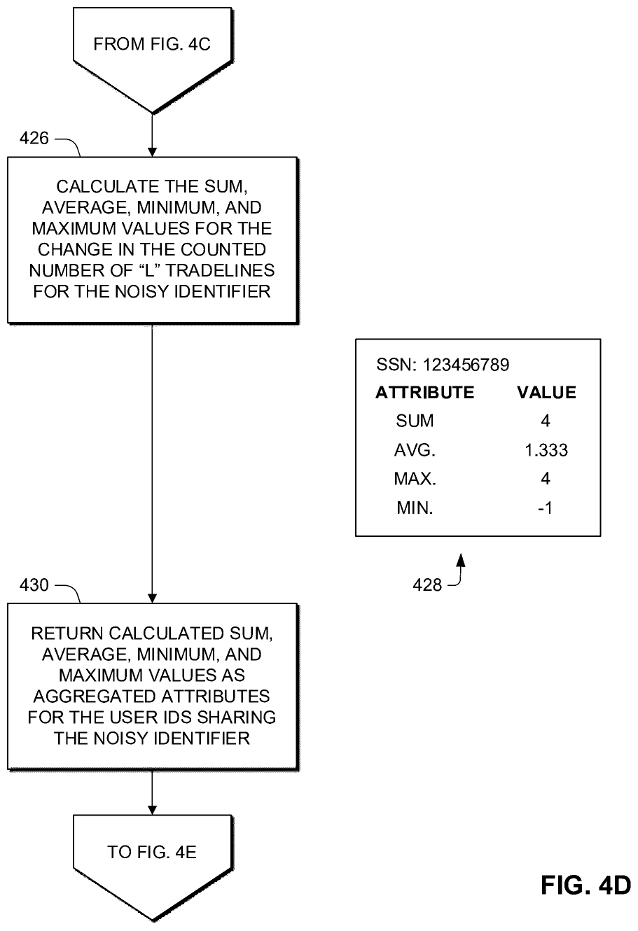

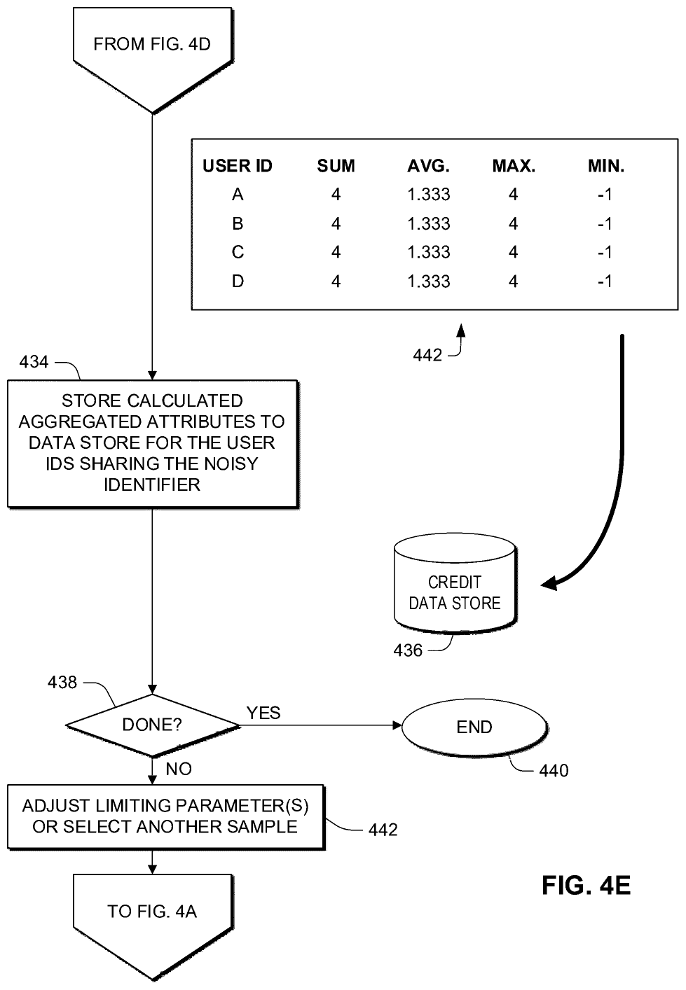

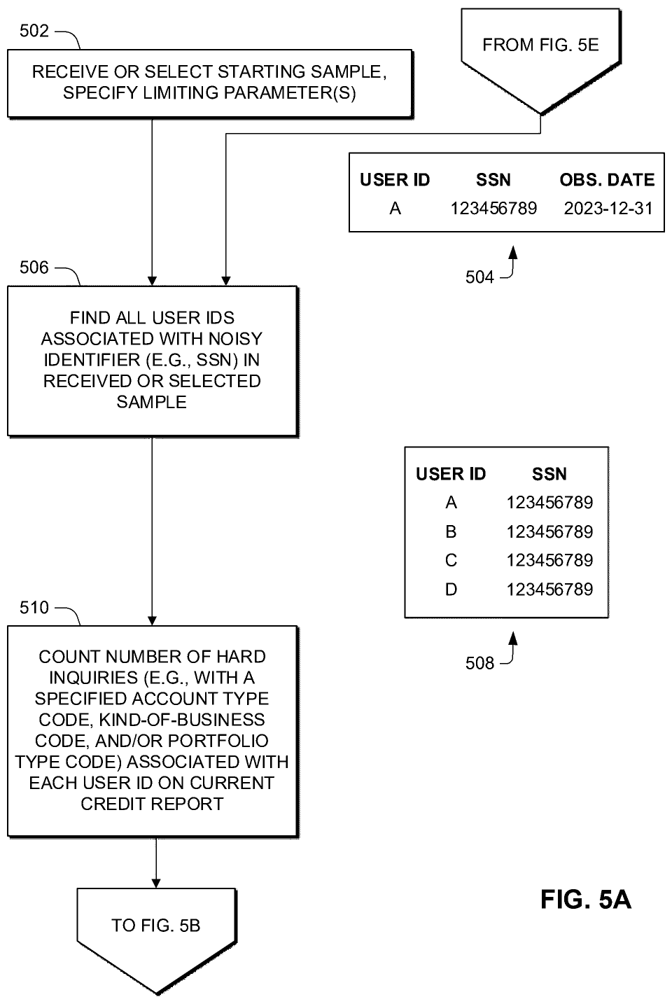

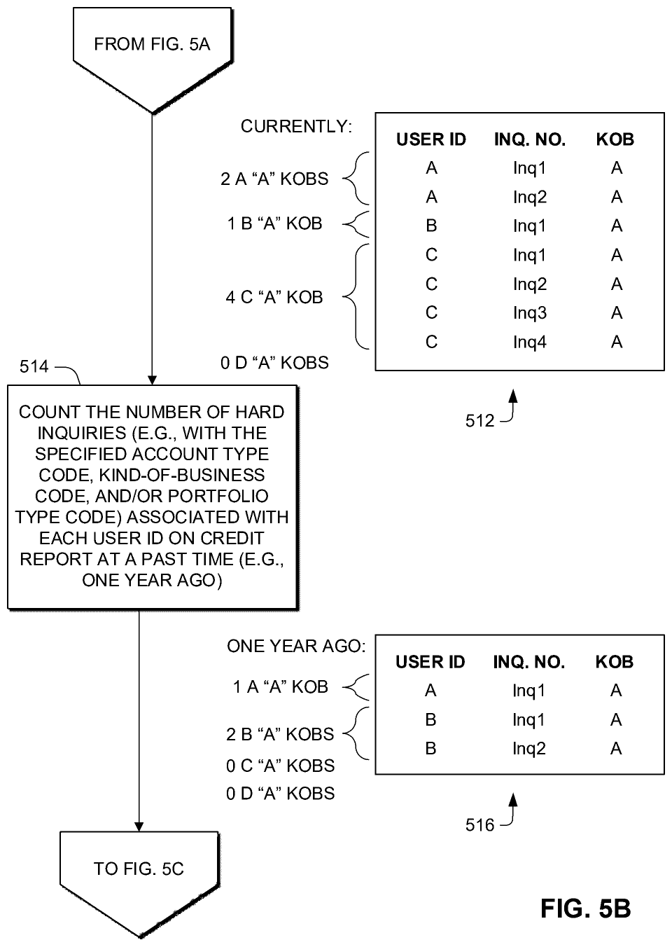

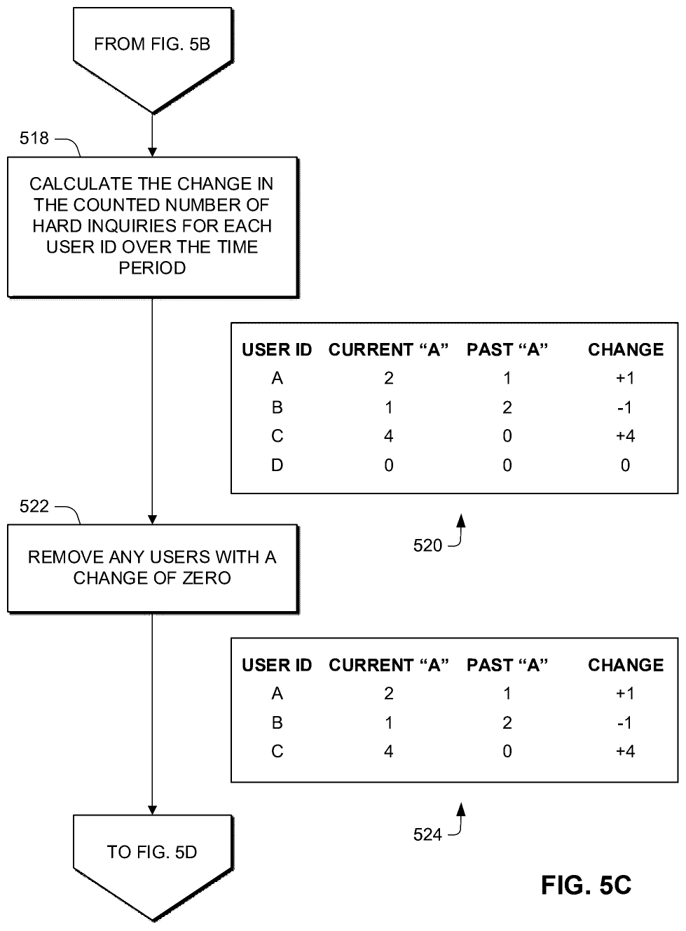

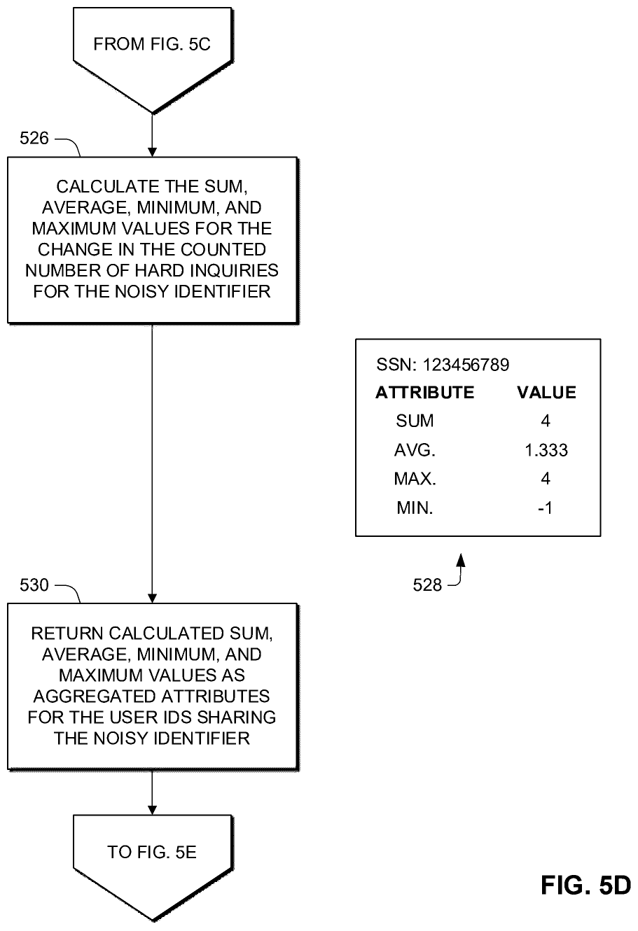

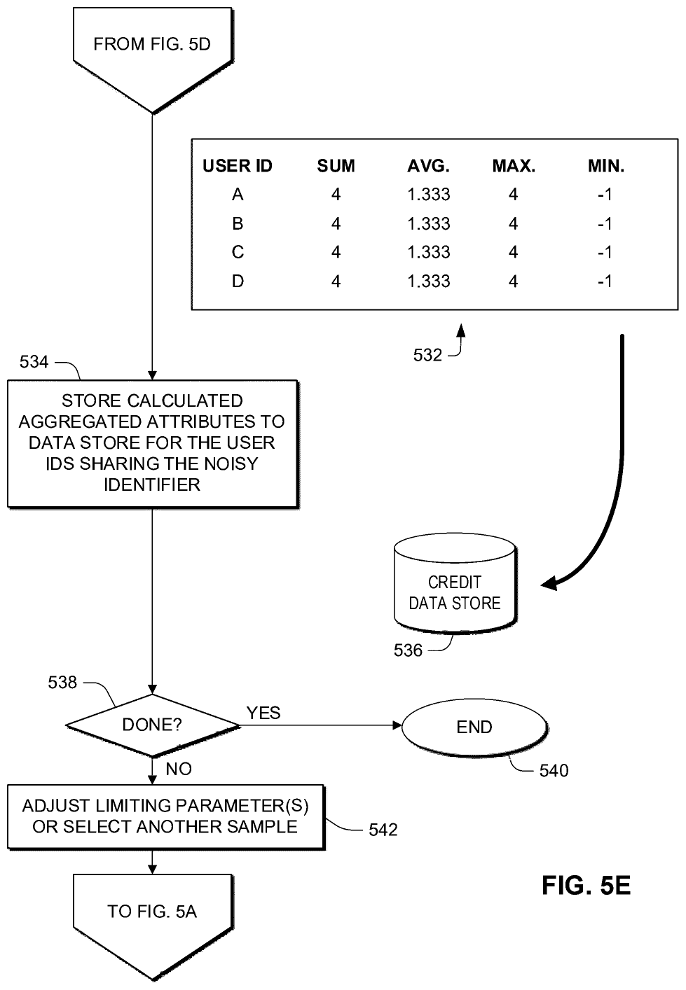

Aggregated attribute module 116 can be configured to retrieve, compute, and/or compile aggregated attribute data based on noisy identifier 117 and data in data store 118 and/or third-party data store 122. Noisy identifier 117 can be a value generated or determined by aggregated attribute module 116 and/or can be provided by an outside source, such as client device 104A. The aggregated attribute data can be computed and stored back to data store 118 for later retrieval, and/or can be transmitted, e.g., to a client device 104A, via network 102. Aggregated attribute module 116 can compute the aggregated attribute data such that the aggregated attribute data is not necessarily traceable to a particular user. Aggregated attribute module 116 can compute the aggregated attribute data using a method as described, for example, with regard to FIG. 3, FIGS. 4A through 4E, and/or FIGS. 5A through 5E.

According to some aspects of this disclosure, account management module 114 may provide account management services within data environment 100. Account management module 114 may generate, modify, and delete accounts (e.g., accounts associated with individuals or entities authenticated to various ones of the client devices 104A through 104N) and may assign appropriate access permissions based on inputs from client device 104A. Account management module 114 may include and/or communicate with a configuration repository (not shown) to retrieve and store account information and access permission data. Interface module 108 can allow client device 104A to interact with an account management module 114 to generate, modify, and/or delete client device accounts (e.g., cloud-based client device accounts) and/or user accounts (e.g., credit applicant and/or credit offer target accounts), manage access permissions, and configure and/or manipulate configurations for the accounts. Separate accounts may be associated with different configurations. The configurations may define scaling policies, security settings, and/or the like. By generating, supporting, and maintaining different configurations in accounts, account management module 114 can ensure the appropriate separation of client environments and/or credit applicant and/or credit offer target information to reduce potential security risks and facilitate the credit offer determination process. For example, different ones of client devices 104A through 104N may be in the custody and/or control of different entities (e.g., different enterprise organizations, e.g., different lenders), all of which may be serviced by credit data server 110. Account management module 114 can therefore generate and make use of permission data to ensure that one enterprise organization is not able to use its respective client device 104A to view, modify, or delete account information belonging to a different enterprise organization.

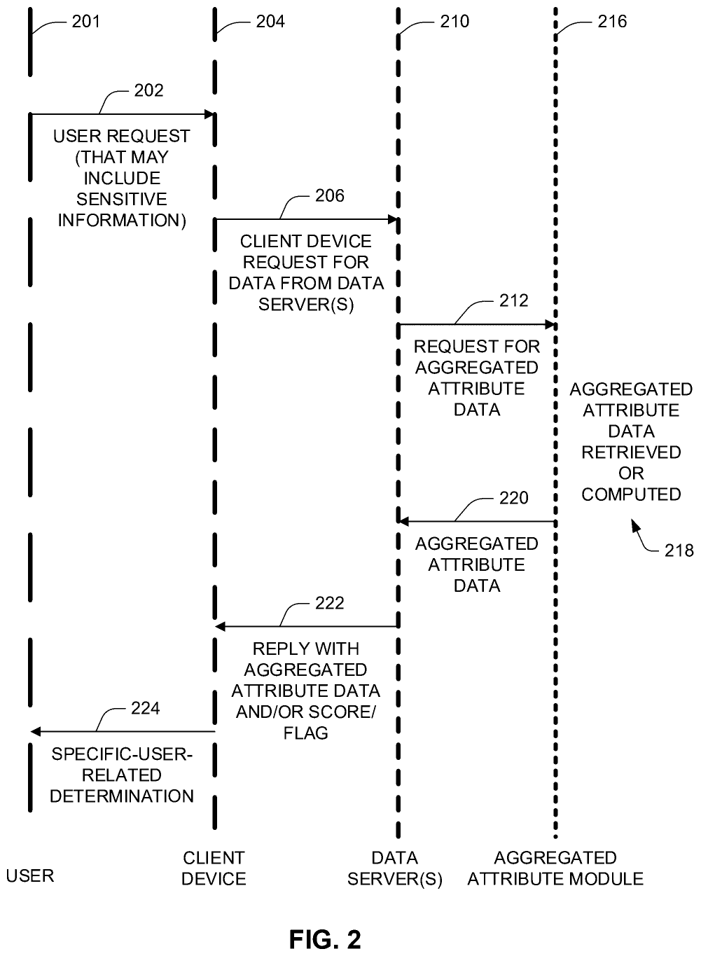

FIG. 2 shows an example sequence of interactions by which an entity using a client device 204, such as client device 104A of FIG. 1, can provide a determination 224 (e.g., credit offer, credit approval, credit denial, or pre-screened credit offer) related to a specific user 201 (e.g., a credit applicant or credit offer target) based on aggregated attribute data, according to aspects of this disclosure. Although the sequence in FIG. 2 is described with reference to FIG. 1, performance of the sequence is not limited to the context of the environment 100 of FIG. 1.

At 202, a user 201, such as a credit applicant, may provide a user request (e.g., a request for credit) to a client device 204. The user request can take the form of a user input 101, which can be submitted in any of the ways described above (e.g., in person, over the telephone, on paper, via electronic form, etc.). For example, credit requested can take any of a number of forms as described herein (e.g., mortgage loan, personal line of credit, credit card, etc.). The request made by the user 201 at 202 can include sensitive data, such as credit data and/or PII. Client device 204 can be, for example, any of the one or more client devices 104A through 104N in FIG. 1.

At 206, client device 204 makes a request for data from one or more data servers 210. For example, the request made by client device 204 at 206 can include a request for a credit score and/or accompanying data, which can include aggregated attribute data, from the one or more data servers 210, which can correspond to the one or more data servers 110 in FIG. 1. The client device request at 206 can be of the form of one or more electronic messages that can travel via a network, e.g., network 102 in FIG. 1. The client device request at 206 can be made based on sensitive user information supplied with the user request at 202 from user 201, or can be made even in the absence of such a user request at 202, e.g., to filter a list of potential credit offer targets. In some examples, the client device request at 206 can include a starting sample that includes at least one noisy identifier (e.g., an SSN). In other examples, the starting sample can be provided by the one or more data servers 210.

At 212, the one or more data servers 210 can generate a request for aggregated attribute data based on the request at 206. An aggregated attribute module 216, which can correspond, for example, to aggregated attribute module 116 in FIG. 1, can, at 218, retrieve or compute aggregated attribute data. For example, based on the requested aggregated attribute data having already been computed, the aggregated attribute module 216 can retrieve at 218 the requested aggregated attribute data from a location where it is stored, e.g., a database, data lake, or other data store, e.g., corresponding to data store 118 in FIG. 1. Alternatively, e.g., based on the requested aggregated attribute data not having been already computed, the aggregated attribute module 216 can compute the requested aggregated attribute data. The aggregated attribute data can be computed at 220, for example, based on a starting sample that can provide a noisy identifier corresponding to a unique (non-noisy) user identifier. The starting sample can be provided with the request at 206 or can be generated by the aggregated attribute module 216. Examples of computation of aggregated attribute data are described below with regard to FIGS. 4A through 4E and FIGS. 5A through 5E.

At 220, having retrieved or computed the aggregated attribute data at 220, the aggregated attribute module 216 can return the retrieved or computed aggregated attribute data. One or more of the one or more data servers 210 can also retrieve other data, such as a credit score and/or other credit attributes.

At 222, the one or more data servers 210 can then reply to the client device request made at 206 by transmitting a reply to the requesting client device 204 (and/or a different client device, as may be directed). In some examples, the reply transmitted at 222 can include the aggregated attribute data retrieved or computed at 218. In some examples, the reply transmitted at 222 can additionally or alternatively include a score, flag, or other value derived from the aggregated attribute data retrieved or computed at 218. For example, the one or more data servers 210 can use a machine learning model to derive the score, flag, or other value from the aggregated attribute data. In some examples, the reply at 222 to the requesting client device 204 (and/or a different client device, as may be directed) can include a credit score and/or accompanying data. According to some aspects of this disclosure, client device 204 may apply one or more analytics and/or machine learning algorithms to derive valuable insights from the information received in the reply from the one or more data servers 210 made at 222 (e.g., the aggregated attribute data). These insights may be utilized to enhance an entity's services, personalize user experiences, inform business strategies, and/or the like. For example, insights based on the aggregated attribute data can inform a determination related to a specific user, such as a decision as to whether credit is offered or extended to a user 201 or a different user, such as a credit applicant or credit offer target, by a lender in control of client device 204.

At 224, the receiving client device 204 may take appropriate action based on the received reply made at 222, which may include a credit score and/or accompanying data including the aggregated attribute data or a score and/or flag based thereon. In some examples, client device 204 can transmit a credit approval or denial to a credit applicant who is user 201 based on the received reply made at 222. In other examples, client device 204 can transmit a pre-screened credit offer to a credit offer target who is user 201 based on the received reply made at 222. In any of these examples, the transmission at 224 can be electronic, by paper mail, over a telephonic or videoconference call, or in person, and can make use of a human or automated agent.

The transmission sequence illustrated in FIG. 2 can be aided by processing logic that can comprise hardware (e.g., circuitry, dedicated logic, programmable logic, microcode, etc.), software (e.g., instructions executing on a processing device), or a combination thereof. Not all steps may be needed to perform the disclosure provided herein. Further, some of the transmissions may be performed simultaneously or in a different order than shown in FIG. 2.

### Example Method of Computing Aggregated Attributes

FIG. 3 illustrates an example method 300 for calculation of aggregated attributes, such as may be performed by aggregated attribute module 116 in FIG. 1 or 216 in FIG. 2. The aggregated attributes can be calculated based on data in a data store, such as data store 118 in FIG. 1. The data in the data store can include records, each of the records being associated with a user (e.g., an individual or an entity). The example method illustrated in FIG. 3 can be aided by processing logic that can comprise hardware (e.g., circuitry, dedicated logic, programmable logic, microcode, etc.), software (e.g., instructions executing on a processing device), or a combination thereof. Not all steps may be needed to perform the disclosure provided herein. Further, some of the steps may be performed simultaneously or in a different order than shown in FIG. 3.

At 302, a noisy identifier is received. In some aspects, the receiving the noisy identifier can include selecting the noisy identifier from a set of noisy identifiers stored in a data store, such as data store 118. For example, the noisy identifier can identify a unique individual or entity represented in a data store, such as data store 118, with less than ninety percent confidence, e.g., with between about seventy-five percent and about ninety percent confidence, e.g., between about eighty percent and about ninety percent confidence, e.g., between about eighty-five percent and about ninety percent confidence. In some examples, the noisy identifier is an SSN. In some examples, the noisy identifier is a combination of ambiguous identifiers, such as a combination of name, gender, and date of birth, or a combination of name, gender, and ZIP code. In some aspects, the receiving the noisy identifier can include determining the noisy identifier (e.g., computing or assembling the noisy identifier), e.g., based on a combination of received (e.g., selected or retrieved) ambiguous identifiers.

At 306, user identifiers are fetched from the data store based on the noisy identifier. For example, the user identifiers can each uniquely identify a corresponding individual or entity represented in the data store. Each of the user identifiers can be associated with the noisy identifier in the data store.

At 309, a list of user identifiers is compiled. In some aspects, the list of user identifiers includes users with associated zero and nonzero record change numbers. In some other aspects, the list of user identifiers only includes users with nonzero record change numbers. This process can include a sequence of steps 310 through 322 that are iteratively repeated, or processed in parallel, for each user identifier of the user identifiers fetched at 306 as being associated with the noisy identifier received at 302. Thus, in the description below regarding steps 310 through 322, reference to “the user identifier” means the user identifier of a particular iteration of steps 310 through 322 as selected from the user identifiers fetched at 306.

At 310, a count is made of a first number of records in the data store that match one or more specified attribute criteria, are associated with a first date or first date range, and are associated with the user identifier. The attribute criteria relate to attributes of the records selected for the count at 310, and the specifying of the attribute criteria can result in a subset of all records related to the user identifier being selected for the count at 310. At 314, a count is made of a second number of records that match the one or more specified attribute criteria, are associated with a second date or second date range (e.g., earlier than the first date or first date range), and are associated with the user identifier. At 318, a record change number is calculated for the user identifier by subtracting the second number of the records from the first number of the records. This record change number and the user identifier is added to the aforementioned list of record change numbers and associated user identifiers, except that, at optional action 322, the record change number and its associated user identifier may not be added to the list, or may be removed from the list, based on the record change number being less than a threshold value or outside a threshold range (e.g., based on the record change number equaling zero). In some aspects, optional action 322 may not be performed such that a record change number being less than the threshold value or outside the threshold range (e.g., a record change number equaling zero) and its associated user identifier are added to the list.

At 326, statistical attributes are calculated for each user identifier in the compiled list of user identifiers and associated record change numbers. The calculated statistical attributes can include, as examples, a sum of the record change numbers in the compiled list, an average of the record change numbers in the compiled list, a maximum of the record change numbers in the compiled list, and/or a minimum of the record change numbers in the compiled list. The calculated statistical attributes are the aggregated attributes calculated using method 300 for each of the user identifiers associated with the noisy identifier received at 302. Accordingly, a plurality of user identifiers may all have the same aggregated attributes associated with them.

In some examples, the calculated aggregated attributes can be stored back to the data store, e.g., data store 118, or to another data store, e.g., as associated with each of the corresponding user identifiers for which the aggregated attributes are calculated. In some examples, the calculated aggregated attributes can be stored back to the data store, e.g., data store 118, or to another data store, e.g., as associated with each of the corresponding user identifiers with which the noisy identifier is associated. Additionally or alternatively, in some examples, the calculated aggregated attributes can be transmitted to another device or system, such as client device 104A. Additionally or alternatively, in some examples, the calculated aggregated attributes can be provided to a statistical model or a machine-learning model and can serve as the basis for a score, flag, or alert. The statistical model or machine-learning model can be client-side (e.g., implemented at client device 104A) or server-side (e.g., implemented at data server 110).

In some examples, the compiling at 309 and the calculating at 326 in method 300 are repeated with different other dates substituted as the second date at 314. For example, the aggregated attributes can be calculated for a third date or third date range different from the second date or second date range and earlier than the first date or first date range, with the third date or third date range substituted for the second date or second date range at 314.

In some examples, the one or more specified attribute criteria at 310 and 314 in method 300 are first one or more specified attribute criteria, and the method 300 further includes repeating the compiling at 309 and the calculating aggregated attributes at 326 for second one or more specified attribute criteria different from the first one or more specified attribute criteria. Accordingly, different aggregated attributes can be calculated for the same noisy identifier and even for the same user identifier using different variations of the method 300. The different aggregated attributes can be stored to provide a large number (e.g., hundreds) of different aggregated attributes associated with each user identifier.

### Examples: Tradeline Washing and Inquiry Washing Aggregated Attributes

The following examples illustrate practical applications of the uses of the above-described systems and methods for detecting, flagging, and alerting to suspect user behavior, such as fraudulent behavior. In particular, the examples relate to types of fraud known as tradeline washing and inquiry washing. Automated fraud detection is a field of technology in itself, and cannot be practicably performed other than with technological implementations given the volumes of transactions and transactional data involved, the number of different users for whom checks may need to be performed, and the speed with which transactions must be processed. In their use of a noisy identifier and aggregated attributes and the separation of different computing devices and systems, the following examples provide improvements to the technical field of automated fraud detection by improving security and privacy of user data, e.g., via data separation that restricts certain systems from access to sensitive user data while still providing those systems with beneficial information. For example, thanks to the use of the noisy identifier 117, when receiving aggregated attributes computed for a specified user identifier by data server 110, a client device 104A cannot confidently trace the aggregated attributes to the activities, behavior, or preferences of the specified user.

Data describing or memorializing details of a credit arrangement between a borrower and a lender can be stored in a data store as an account. For any account, one or more credit activity records, called tradelines, may be generated by a lender and reported to one or more credit bureaus. A tradeline can be generated for any type of credit extended to a borrower, and can include such information as the type of credit (e.g., credit card, mortgage, auto loan), the date the account was opened, the credit limit or loan amount, the account balance, the payment history, and/or the status of the account (e.g., current, past due, closed). Because they provide information about a borrower's credit history and behavior, tradelines can play a role in determining a borrower's credit score and in influencing lenders' future lending decisions with regard to the borrower.

Information about so-called hard inquiries, which are lender inquiries into consumer credit reports made when a credit applicant applies for new credit, may also be stored as data associated with respective borrowers' credit records. Because they provide information about a borrower's (or potential borrower's) credit-seeking history and behavior, including potential loan-stacking behavior, hard inquiries can likewise play a role in determining a borrower's credit score and in influencing lenders' future lending decisions with regard to the borrower (or potential borrower).

Fraudulent activity or errors may lead to inclusion of one or more spurious tradelines in a credit record of a borrower or potential borrower. The borrower or potential borrower may make a request to a credit bureau or to a lender who posted a tradeline to remove an allegedly spurious tradeline. The request may be honored such that the allegedly spurious tradeline does not appear in a consumer credit report for the borrower or potential borrower. In most situations, removal of one or more incorrect tradelines from consumer credit reports protects an innocent borrower or potential borrower from the adverse effects of fraud or error. However, a malicious actor can exploit such removal to illegitimately improve a consumer credit record and thereby procure credit that would not have been granted had the tradeline(s) not been removed. The removal of one or more legitimate tradelines from a consumer credit report of a malicious actor and consequent illegitimate improvement in a credit record can be referred to as tradeline washing.

Similarly, in inquiry washing, a credit consumer may request removal of hard inquiry information, and the request may be honored. A potential borrower whose credit record has been illegitimately improved by credit washing, e.g., tradeline washing or inquiry washing, may be unduly extended credit by one or more borrowers unaware of the credit washing activity. Yet current computer systems and networks involved in credit evaluation are not designed to detect and flag such data records. For example, certain data that provides direct evidence of credit washing is not accessible for use in such detection. Accordingly, examples described herein provide technical solutions configured to evaluate credit activity when access to data is limited or otherwise restricted. Similarly, such restricted-data analysis using aggregated attribute information can monitor for and warn of credit washing activity while maintaining the security, privacy, and/or inaccessibility of the individual user data.

Credit washing can include a variety of different activities intended to remove from a consumer credit record unfavorable information so that it is not taken into consideration in credit extension determinations when a lender considers whether to extend credit to a potential borrower or to make a pre-approved or pre-selected offer of credit to a credit offer target. As noted above, types of credit washing include tradeline washing and inquiry washing.

In examples described below, to address the issue of credit washing, an entity-controlled client device may request aggregated attribute data that is informative with respect to credit washing activity, or data that is derived from such aggregated attribute data, such as a determination, score, or flag that is based on or otherwise takes into account the aggregated attribute data. Some examples described herein can provide computing devices used by lenders with aggregated attribute data that can be used to make more informed credit extension or credit offer targeting decisions, without the provided data being directly and confidently traceable to any individual user. Some examples described herein can provide computing devices used by lenders with decision, score, or flag outputs based on the aggregated attribute data. The decision, score or flag outputs can, for example, be outputs of one or more machine learning models trained on credit data, including aggregated attribute data, to help determine whether a potential borrower should be extended credit or targeted with a credit offer. As noted above, the examples described below can offer technical improvements to privacy and security of computer systems and networks.

Embodiments as described herein, which make use of aggregated attributes, advantageously provide lenders with tools to identify abusive or fraudulent behavior from credit applicants or potential credit offer targets, where the abusive or fraudulent behavior results in a decline in reported tradelines with a charge-off status (or other related status), and/or that results in a decline in reported hard inquiries, while complying with credit data restrictions. Some aspects described herein further advantageously permit a credit bureau to leverage its coverage of furnished tradeline data, with a focus on those tradelines that have been charged-off, tracking changes in the number of charged-off tradelines associated with credit files that share the same noisy identifier. The aggregated attributes generated by some described aspects can include calculated sums, averages, minimums, and maximums of temporal changes in charged-off tradelines or inquiries aggregated on the noisy identifier. The aggregated attributes can be provided to a model, such as a scoring model, which can be returned (e.g., as a fraud alert or as part of a score) on a credit report, a model report, and in various batch processes like prescreen, prequalification, portfolio review, or other real-time data feeds accessible, for example, via an application programming interface (API).

The flow diagrams of FIGS. 4A through 4E and FIGS. 5A through 5E illustrate uses of the above-described systems and methods to perform user-related determination using aggregated attributes to detect, flag, or warn of potential tradeline washing and inquiry washing.

### Example One: Computation of Tradeline Washing Aggregated Attributes

FIGS. 4A through 4E show an example method for computation of aggregated attribute data for credit determinations, according to aspects of this disclosure. The example method of FIGS. 4A through 4E can be performed by processing logic that can comprise hardware (e.g., circuitry, dedicated logic, programmable logic, microcode, etc.), software (e.g., instructions executing on a processing device), or a combination thereof. Not all steps may be needed to perform the disclosure provided herein. Some of the steps may be performed simultaneously or in a different order than shown in FIGS. 4A through 4E. Some of the steps may be performed multiple times, serially or in parallel, based on different criteria. The method of FIGS. 4A through 4E is described with reference to FIGS. 1 and 2. However, the method of FIGS. 4A through 4E is not limited to those figures or related aspects.

With reference to FIG. 4A, at 402, aggregated attribute module 116 receives or selects a starting sample. An example starting sample is illustrated at 404. The example starting sample includes three data items: a unique user identifier, a noisy identifier (in the illustrated example, an SSN), and an observation date. The unique user identifier is intended to uniquely identify, with one hundred percent confidence, a single person or entity who is a credit applicant or credit offer target. For example, the unique user identifier identifies only one person or entity in a data store (e.g., data store 118) containing information about multiple credit applicants or credit offer targets. For purposes of simplicity, in the illustrated example, the unique user identifier is illustrated as a single letter (“A”).

In contrast with the user identifier, the noisy identifier does not uniquely identify any single person or entity with one hundred percent confidence, but instead identifies a single person or entity with less than one hundred percent confidence, but greater than zero confidence. The data store may contain entries for multiple different persons or entities corresponding to the noisy identifier. For example, the form of the noisy identifier can advantageously be chosen such that it identifies a single person or entity with less than about ninety percent confidence, e.g., between about seventy-five percent and about ninety percent confidence, e.g., between about eighty percent and about ninety percent confidence, e.g., between about eighty-five percent and about ninety percent confidence. Various non-unique forms of identifiers and combinations of forms of non-unique identifiers can serve as the noisy identifier.

Several data fields of credit data and/or user data may, individually, be poor choices as the form of noisy identifier, but can be combined to make a good form of noisy identifier. Many individuals may be born on the same date, making date of birth a highly non-unique form of identifier, and, when used by itself, a potentially poor form of noisy identifier. Similarly, because of cohabitation, changes in residence, and/or data errors, residential address, by itself, is highly non-unique and a potentially poor form of noisy identifier. A ZIP code encompasses large numbers of individuals and is, by itself, a poor form of noisy identifier. Gender encompasses roughly half the population and likewise, by itself, is a poor form of noisy identifier.

However, because a form of noisy identifier combining a date of birth, a ZIP code, and a gender has been found to identify a single person with an about eighty-seven percent confidence, this combination is a potentially good choice of form of noisy identifier. Because SSN has been found to identify a single person with about eighty-five percent to ninety percent confidence, in some examples, SSN can be chosen as the form of noisy identifier. Although SSN should ideally be a unique identifier, in practice this is not the case, because of intentional or unintentional errors in SSN reporting by credit applicants and other data errors. Accordingly, SSN data is noisy data that makes it an imperfectly reliable indicator of identity and thus a potentially good noisy identifier. A combination of name, gender, and date of birth is another potentially good choice of form of noisy identifier.

Also at 402, one or more limiting parameters may be specified. The limiting parameters can, for example, specify the timeframe used at 414. The limiting parameters can also limit the scopes of data store searches performed in making the tradeline counts at 410 and 414 to arrive at the calculated tradeline changes at 418 and thus to determine the aggregated attributes calculated at 426, as described in greater detail below. For example, the limiting parameters can specify the tradelines to be matched when performing the counts, e.g., by specifying one or more account rating profile codes to be matched, one or more manner of payment codes to be matched, one or more rating remark codes to be matched, and/or payment pattern text to be matched when searching for tradelines associated with a particular user identifier. In the example illustrated in FIGS. 4A through 4E and described below, the limiting parameter specified at 402 specifies that counted tradelines have account rating profile code “L,” but, as described below, additional or different account rating profile codes can be matched, and/or other tradeline matching criteria can be specified. Different tradeline matching criteria can be specified to calculate different aggregated attributes, and the method of FIGS. 4A through 4E can be repeated, serially or in parallel, to calculate a variety of different aggregated attributes.

Still with reference to FIG. 4A, at 406, aggregated attribute module 116 finds all unique user identifiers associated with the noisy identifier in the received or selected sample. For example, the aggregated attribute module 116 can query one or more databases of the data store 118 and/or third-party data store 122 to retrieve the user identifiers associated with the noisy identifier. In examples where SSN is used as the noisy identifier, a user does not necessarily have to have the same SSN listed as a primary SSN for the user in order to be included in the user identifier collection at 406. Any association with the searched SSN on any account is sufficient for inclusion of the user identifier at 406. A user identifier can have multiple SSNs associated with the user identifier for a variety of reasons. Different SSNs can become associated with a user identifier through misreporting due, e.g., to typographical errors, misremembering, or intentional (e.g., fraudulent) misreporting. Different SSNs can become associated with a user identifier by account association with other users, e.g., joint or co-borrowers or authorized users.

An example result of the query 406 is shown at 408. In the example result 408, four user identifiers A through D are returned as being associated with the SSN associated with user A. As described above, the one or more databases of the data store 118 and/or third-party data store 122 may include one or more tables with the user data, and aggregated attribute module 116 in some examples can be configured to search the data tables with an appropriately formatted data query language (DQL) query, such as a Structured Query Language (SQL) query, to return the desired user identifiers.

Still with reference to FIG. 4A, at 410, for each respective user identifier in the user identifiers found at 406, aggregated attribute module 116 counts the number of tradelines, from a data archive of tradelines dated within a defined timespan, e.g., within the last month or within the current calendar month, that are associated with the respective user identifier and that have an account rating profile code that is found in a list of specified account rating profile codes (charge-off account rating profile code “L” in the illustrated example). For example, the aggregated attribute module 116 can search the data archive (e.g., one or more tradelines tables in the data archive) for current-month tradelines with a specified account rating profile code (e.g., charge-off account rating profile code “L”) and then count the results by unique user identifier. In various other examples, not illustrated, rather than, or in addition to, counting the number of tradelines having a charge-off account rating profile code (e.g., “L”), the method can count the number of tradelines having a collection account rating profile code (e.g., “G”), having a foreclosure account rating profile code (e.g., “H”), having a voluntary surrender account rating profile code (e.g., “J”), having a repossession account rating profile code (e.g., “K”), and/or having any of these profile codes, or any of some combination of these profile codes. In still other examples, not illustrated, rather than, or in addition to, counting the number of tradelines having one or more of the above account rating profile codes, the method can count the number of tradelines matching a specified manner of payment code, a specified rating remark code, a specified account type code, and/or specified payment pattern text. Specifying the account type code can permit analysis of types of tradelines by line of business (LOB), such as auto loan/lease, bank card, personal loan, or retail card, to name a few examples.

Now with reference to FIG. 4B, an example result of the current “L” tradeline count 410 is shown at 412. As shown in the illustrated example, two account numbers are presently found to have “L” account ratings for user A, one account number for user B, four account numbers for user C, and none for user D. At 414, for each respective user identifier in the user identifiers found at 406, aggregated attribute module 116 counts the number of tradelines matching the specified account rating profile code, manner of payment code, rating remark code, account type code, and/or payment pattern text at a specified past time. The specified account rating profile code, manner of payment code, rating remark code, and/or payment pattern text is the same as used at 410. The specified past time can be, as examples, three, six, nine, twelve, eighteen, twenty-four, thirty-six, forty-eight, or sixty months prior. For example, the aggregated attribute module 116 can search the data tables (e.g., one or more tradelines tables) for specified-past-time tradelines in the data archive with a specified account rating profile code (e.g., “L”) and then count the results by unique user identifier. An example result of the past-time “L” tradeline count 414 is shown at 416. As shown in the illustrated example, one account number is found to have an “L” account rating for user A at the specified past time (one year ago in the given example), two account numbers are found to have an “L” account rating for user B at the specified past time, and none for users C and D.

Now with reference to FIG. 4C, at 418, for each respective user identifier in the user identifiers found at 406, aggregated attribute module 116 calculates the change in the counted number of tradelines over the time period between the present time and the specified past time. For example, the aggregated attribute module 116 can subtract the past-time “L” tradeline number values counted at 414 from the current “L” tradeline number values counted at 410. An example result of the “L” tradeline number change computation 418 is shown at 420. As shown in the illustrated example, user A is computed to have a change of +1, user B is computed to have a change of −1, user C is computed to have a change of +4, and user D is computed to have a change of zero. In the illustrated example, at 422, aggregated attribute module 116 removes, from the list of difference values calculated at 418, any users with a change of zero. Thus, as shown in the example result 424, the difference entry for user D is removed from the list. In some aspects, 422 is skipped such that any users with a change of zero are not removed from the list of difference values. However, the remainder of the description of the method of FIGS. 4A through 4E will show nonzero records as removed from the list for consistency of explanation. In some aspects, the removal at 422 can be with regard to a different value than zero. For example, the criteria for removal at 422 can be that the change is less than a threshold value or outside a threshold range.

Now with reference to FIG. 4D, at 426, aggregated attribute module 116 calculates the aggregated attributes relevant to tradeline washing, such as the sum, average, minimum, and maximum values for the list of values representing the change in the counted number of “L” tradelines for the noisy identifier. In the illustrated example, as shown at 424, the list includes the values +1, −1, and +4. An example result of the attributes calculation 426 is shown at 428. As shown in the illustrated example, the sum of the change list in 424 is calculated as 1−1+4=4, the average of the list is calculated as (1−1+4)/3=1.333 (to within four significant digits—other precisions are possible in other examples), the maximum of the list is calculated as max(1, −1, 4)=4, and the minimum of the list is calculated as min(1, −1, 4)=−1. At 430, aggregated attribute module 116 returns the calculated aggregated attributes relevant to tradeline washing calculated at 426 for the user identifiers sharing the noisy identifier.

With reference to FIG. 4E, an example table of reported aggregated attribute values relevant to tradeline washing is shown at 432. At 434, aggregated attribute module 116 stores these calculated aggregated attributed values to a data store, illustrated at 436, which can correspond, for example, to data store 118 in FIG. 1.

The above-described process can be repeated, or performed in parallel, to compute aggregated attributes additional to the four shown for the same starting sample, and/or to compute aggregated attributes for a different starting sample. Accordingly, at 438, the aggregated attribute module 116 determines whether the process of computing aggregated attribute values relevant to tradeline washing is done. For example, if all aggregated attributes of interest, relevant to tradeline washing, have been computed (or attempted to be computed) for all user identifiers known in the data store 118, then it can be determined 438 that the process of computing aggregated attribute values relevant to tradeline washing is done and the process can end 440. To periodically refresh the aggregated attribute values relevant to tradeline washing for each user identifier, the process of FIGS. 4A through 4E can be intermittently repeated for all user identifiers, e.g., once per month, once every two weeks, once every week, twice per week, or once every day.

Based on determining 438 that the process is not done, e.g., that limiting parameters can be adjusted and/or that aggregated attributes relevant to tradeline washing can be computed for more user identifiers, the process can continue, at 442, by adjusting one or more limiting parameters or selecting another sample. For example, to select another sample, a new noisy identifier can be chosen, different from the one used to select the starting sample at 402, and a data store (e.g., data store 118 and/or third-party data store 122) can be searched 406 for user identifiers matching the new noisy identifier. For example, the user identifiers can be processed (e.g., sequentially) until all user identifiers (or a desired fraction of user identifiers) have had all desired aggregated attributes computed for them.

To compute aggregated attributes additional to the four shown at 432 for the same starting sample, limiting parameters can be added or varied in the process illustrated in FIGS. 4A through 4E. Although in the illustrated examples only four aggregated attributes relevant to tradeline washing are computed for each user identifier, a large number of aggregated attributes can be computed, e.g., over 100 different aggregated attributes, e.g., over 300 different aggregated attributes, e.g., 360 different aggregated attributes. One limiting parameter that can be adjusted is the time difference between charge-off counts, which dictates the past time selected to perform the count at 414. For example, although the illustrated example only shows each of the four aggregated attributes being computed for a single selected past time, the process can be repeated (or performed in parallel) to compute additional aggregated attributes for multiple time differences, e.g., multiple differences between the current monthly archive and monthly archives of the past three, six, nine, twelve, eighteen, twenty-four, thirty-six, forty-eight, and sixty months, and/or no time difference at all.

Another limiting parameter that can be adjusted is tradeline loan type. For example, rather than counting all tradelines with charge-off account ratings at 410 and 414, the counted number of tradelines can be limited to tradelines for a certain kind of loan, such as automobile purchase loan tradelines, bank card credit line tradelines, retail card credit line tradelines, collections tradelines, or personal loan tradelines. Thus, although the illustrated example only shows each of the four aggregated attributes being computed for all types of tradelines viewed in the collective, the process can be repeated (or performed in parallel) to compute additional aggregated attributes limited to the different loan types of tradelines. This limiting parameter can be adjusted, for example, by specifying an account type code, as described above, e.g., by limiting the database searches performed at 410 and 414 by adding a tradeline loan type limitation to the search query, for each desired loan type.

Other aggregated attributes relevant to tradeline washing that can be computed and stored include number of user identifiers for a given noisy identifier with no charged-off tradelines, e.g., at present or over any given time period, e.g., over the past three, six, nine, twelve, twenty-four, thirty-six, forty-eight, and/or sixty months; number of user identifiers for a given noisy identifier with a decrease in charged-off tradelines over any given time period; number of user identifiers for a given noisy identifier with an increase in charged-off tradelines over any given time period; and/or number of user identifiers for a given noisy identifier with charged-off tradelines, e.g., at present or over any given time period. These aggregated attributes relevant to tradeline washing can be computed and stored for tradelines of all types of loans viewed in the collective, and/or as limited to various particular tradeline loan types (e.g., auto, bank card, collections, personal loan, retail card, or any of the above taken collectively).

Examples of aggregated attributes relevant to tradeline washing include “average number of tradelines with a current charge-off status for user identifiers sharing the selected noisy identifier (e.g., SSN) with the credit applicant,” “sum of difference in number of personal loan tradelines with a current charge-off status compared to tradelines with a charge-off status three months prior for user identifiers sharing the selected noisy identifier with the credit applicant,” “minimum difference in number of collection tradelines with a current charge-off status compared to tradelines with a charge-off status sixty months prior for user identifiers sharing the selected noisy identifier with the credit applicant,” “maximum number of retail card tradelines with a current charge-off status for user identifiers sharing the selected noisy identifier with the credit applicant,” “number of user identifiers that have no tradelines with a current charge-off status among user identifiers sharing the selected noisy identifier with the credit applicant,” “number of user identifiers that have auto tradelines with a current charge-off status among user identifiers sharing the selected noisy identifier with the credit applicant,” “number of user identifiers that have an increase in bank card tradelines with a current charge-off status compared to bank card tradelines with a charge-off status three months prior among user identifiers sharing the selected noisy identifier with the credit applicant,” and “number of user identifiers that have an increase in personal loan tradelines with a current charge-off status compared to personal loan tradelines with a charge-off status thirty-six months prior among user identifiers sharing the selected noisy identifier with the credit applicant.”

Considering all the timeframe and loan type parameter variations possible in computing aggregated attributes relevant to tradeline washing, the number of computed aggregated attributes relevant to tradeline washing for a given noisy identifier can be large, e.g., about 360. Considering also the number of user identifiers, which can be, e.g., in the hundreds of millions or the billions, the number of aggregated attribute values to be computed and/or stored by a process such as the one described above with regard to FIGS. 4A through 4E can be large, e.g., in the hundreds of millions, billions, or trillions. Available computing resources (processor cycles, memory, storage, etc.) for performing the above method over all user identifiers in the applicable data store(s) may dictate how much time is required to refresh the aggregated attributes and thus how frequently the refresh process is repeated (e.g., whether it is performed once per month, once every two weeks, once every week, twice per week, or once every day).

With view again to FIG. 1 or 2, when a client device 104A or 204 makes a request 202 to a data server 110 or 210 for aggregated attributes relevant to tradeline washing for a specified noisy identifier or a specified user identifier, a pre-computed set of aggregated attribute values relevant to tradeline washing for the specified noisy identifier or specified user identifier can be retrieved 218 from the data store 118 and returned 222 to the client device 104A or 204. In the event that aggregated attribute values relevant to tradeline washing have not been computed, or have not been all computed, or have not been recently computed, for the specified noisy identifier or specified user identifier, aggregated attribute module 116 or 216 can be configured to newly compute 218 the requested aggregated attributes and deliver 220 them accordingly, e.g., by using the aggregated attribute computation process described above with regard to FIGS. 4A through 4E.

The following description provides an example functioning of aggregated attributes embodiments when aggregated attributes are used to evaluate the creditworthiness of a credit applicant or credit offer target identifiable as user B in the example of FIG. 4E. A client device 104A or 204 may receive 222 aggregated attributes such as those shown at 422 responsive to a request 206 to the data server 110 or 210 for credit data including aggregated attribute data for a credit applicant or credit offer target identifiable as user B. The client device 104A or 204 may, in some examples, provide as part of its request 206 a noisy identifier (e.g., the SSN) for the credit applicant or credit offer target user B, or, in some examples, the data server 110 or 210 may determine a noisy identifier of the user B based on a search of data stored in data store 118. Provision or determination of a noisy identifier is, however, not necessary where the aggregated attributes 422 have already been computed, e.g., using the process of FIGS. 4A through 4E, at a time prior to the transmission of the request 206. The received 222 aggregated attributes may, in some examples, be limited only to those for a queried credit applicant or credit offer target, such as, in the present example, user B. Accordingly, in the present example, responsive to the request 206, data server 110 or 210 may transmit 222 to the client device 104A or 204 only aggregated attributes for user B, such as sum 4, average 1.333, maximum 4, minimum −1 and/or other aggregated attributes as described above (e.g., about 360 different aggregated attribute values relevant to tradeline washing per user identifier).

Based on receiving these aggregated attribute values, the client device 104A or 204 may determine, for example, that there is a superthreshold risk that the credit record of user B has been subject to tradeline washing, and that the credit record of user B should be subjected to further scrutiny before extending an offer of credit to the credit applicant or credit offer target identified as user B. This may be an appropriate determination even though the aggregated attributes do not in themselves specifically reflect, as shown at 420, that user B in particular has had one past “L” tradeline removed from the consumer credit report of user B. The aggregated attributes relevant to tradeline washing do not reflect this because the aggregated attributes represent an aggregation of data based on a noisy identifier that does not identify user B with full confidence.

The following description now provides an example functioning of aggregated attributes embodiments when aggregated attributes are used to evaluate the creditworthiness of a credit applicant or credit offer target identifiable as user D in the example of FIG. 4E. A client device 104A or 204 may receive 222 aggregated attributes such as those shown at 422 responsive to a request 206 to the data server 110 or 210 for data including aggregated attribute data for a credit applicant or credit offer target identifiable as user D. The client device 104A or 204 may, in some examples, provide as part of its request 206 a noisy identifier (e.g., the SSN) for the credit applicant or credit offer target user D, or, in some examples, the data server 110 or 210 may determine a noisy identifier of the user D based on a search of data stored in data store 118. Provision or determination of a noisy identifier is, however, not necessary where the aggregated attributes 422 have already been computed, e.g., using the process of FIGS. 4A through 4E, prior to the request 206. The received 222 aggregated attributes may, in some examples, be limited only to those for a queried credit applicant or credit offer target, such as, in the present example, user D. Accordingly, in the present example, responsive to the request 206, data server 110 or 210 may transmit 222 to the client device 104A or 204 only aggregated attributes for user D, such as sum 4, average 1.333, maximum 4, minimum −1 and/or other aggregated attributes as described above (e.g., 360 different aggregated attribute values per user identifier).

Based on receiving these aggregated attribute values, the client device 104A or 204 may determine, for example, that there is a superthreshold risk that the credit record of user D has been subject to credit washing, and that the credit record of user D should be subjected to further scrutiny before extending an offer of credit to the credit applicant or credit offer target identified as user D. This may be the case even though, as shown at 420, user D has not had any charged-off (“L”) tradelines, removed or otherwise, in the consumer credit report of user D during the examined time period reflected in the returned aggregated attribute values. The above description of the process as applied to user D illustrates that, by design of the process, the process can sometimes flag for potential tradeline washing users with no actual tradeline washing in their credit histories. This is because the process relies on aggregated data to determine the aggregated attributes and does not, from the perspective of the client device 104A or 204, directly examine data in a user's credit file to determine a risk of credit washing.

The computed aggregated attributes are “aggregated” in that they pertain to a particular credit applicant or offer target with less than one-hundred percent confidence, e.g., less than ninety percent confidence, e.g., between about seventy-five percent and about ninety percent confidence, e.g., between about eighty percent and about ninety percent confidence, e.g., between about eighty-five percent and about ninety percent confidence. By separating the functions of data servers 110 from those of client device 104A and by providing a noisy identifier and aggregated attribute values, reasonable accuracy can be maintained when data is restricted by replacing what would otherwise be a simple lookup call for data in a data store with a multi-step process configured to block access to restricted data. This multi-step process provides a technical advantage because a client device 104A (e.g., a lender) can be prevented from accessing sensitive data while still being provided with useful determinations related to a specific user, or non-sensitive data on which the determinations can be based. Moreover, various practical applications of the disclosed technology are also described, which provide further practical benefits to users and operators that are also new and useful improvements in the art.

### Example Two: Computation of Inquiry Washing Aggregated Attributes

The example of FIGS. 4A through 4E can be adapted to generate and store aggregated attribute data relevant to detection of credit washing issues indicative of credit risk other than tradeline washing, such as inquiry washing. FIGS. 5A through 5E show another example method for computation of aggregated attribute data for credit determinations, according to aspects of this disclosure. Whereas the example method of FIGS. 4A through 4E as described above generates and stores aggregated attribute data relevant to detection of tradeline washing for a specified user identifier, the example method of FIGS. 5A through 5E as described below generates and stores aggregated attribute data relevant to detection of inquiry washing for a specified user identifier. The description of the method of FIGS. 4A through 4E applies to the method of FIGS. 5A through 5E, with differences as particularly pointed out below.

With reference to FIG. 5A, at 502, aggregated attribute module 116 receives or selects a starting sample. The example starting sample illustrated at 504 is the same as the starting sample 404 described above, and likewise uses SSN as an example form of noisy identifier, but, as described above, other forms of noisy identifier may be used in other examples. Also at 502, one or more limiting parameters may be specified. The limiting parameters can, for example, specify the timeframe used at 514. The limiting parameters can also limit the scopes of data store searches performed in making the inquiry counts at 510 and 514 to arrive at the calculated inquiry changes at 518 and thus to determine the aggregated attributes calculated at 526, as described in greater detail below. For example, the limiting parameters can specify the inquiries to be matched when performing the counts, e.g., by specifying one or more account type codes to be matched, one or more kind-of-business codes to be matched, and/or one or more portfolio type codes to be matched when searching for inquiries associated with a particular user identifier. In the example illustrated in FIGS. 5A through 5E and described below, the limiting parameter specified at 502 specifies that counted inquiries should have kind-of-business code “A,” but, as described below, additional or different kind-of-business codes can be matched, account type codes can be matched, portfolio type codes can be matched, and/or other inquiry matching criteria can be specified. Different inquiry matching criteria can be specified to calculate different aggregated attributes, and the method of FIGS. 5A through 5E can be repeated, serially or in parallel, to calculate a variety of different aggregated attributes.

At 506, aggregated attribute module 116 finds all unique user identifiers associated with the noisy identifier in the received or selected sample. For example, the aggregated attribute module 116 can query one or more databases of the data store 118 and/or third-party data store 122 to retrieve the user identifiers associated with the noisy identifier. An example result of the query 506 is shown at 508.

Still with reference to FIG. 5A, at 510, for each respective user identifier in the user identifiers found at 506, aggregated attribute module 116 counts a number of hard inquiries from a data archive of inquiries date within a defined timespace, e.g., within the last month or within the current calendar month, that are associated with the respective user identifier. For example, aggregated attribute module 116 can, for each corresponding user identifier, count a number of hard inquiries in the data archive with a specified account type code, KOB code, and/or portfolio type code. For example, the aggregated attribute module 116 can search the data archive (e.g., one or more inquiries tables in the data archive) for currentmonth hard inquiries, e.g., with the specified account type code, KOB code, and/or portfolio type code, and then can count the results by unique user identifier. As an example, an auto inquiry can be searched according to the following conditions: (a) the account type code is either “AL” or “AU”, or (b) the first character in the KOB code is “A” and the second character in the KOB code is “A,” “C,” “L,” “N,” “U,” “Z,” or blank, or (c) the first character in the KOB code is “B,” “F,” “Q,” or “Z” and the second character in the KOB code is “A.” The precise search requirements can depend on how the data archive is structured and how various codes are defined.

Now with reference to FIG. 5B, an example result of the current hard inquiry count 510 is shown at 512. As shown in the illustrated example, two inquiry numbers are presently found to have “A” KOB codes for user A, one inquiry number for user B, four inquiry numbers for user C, and none for user D. At 514, for each respective user identifier in the user identifiers found at 506, aggregated attribute module 116 counts the number of hard inquiries in the data archive within a specified past time. For example, aggregated attribute module 116 can, for each corresponding user identifier, count a number of hard inquiries in at the data archive within the specified past time with the specified account type code, KOB code, and/or portfolio type code (as specified at 510). The specified past time can be, as examples, one, three, seven, fifteen, thirty, sixty, ninety, one-hundred eight, or three-hundred sixty-five days prior. For example, the aggregated attribute module 116 can search the data tables (e.g., one or more inquiries tables) for specified-past-time-credit-report hard inquiries, e.g., with the specified account type, KOB, and/or portfolio type codes, and then can count the results by unique user identifier. An example result of the past-time “A” KOB code count 514 is shown at 516. As shown in the illustrated example, one inquiry number is found to have an “A” KOB code for user A at the specified past time (three-hundred sixty-five days ago in the given example), two inquiry numbers are found to have an “A” KOB code for user B at the specified past time, and none for users C and D.

Now with reference to FIG. 5C, at 518, for each respective user identifier in the user identifiers found at 506, aggregated attribute module 116 calculates the change in the counted number of tradelines over the time period between the present time and the specified past time. In the given example, the aggregated attribute module 116 subtracts the past-time “A” KOB code values counted at 514 from the current “A” KOB code values counted at 510. An example result of the “A” KOB code count change computation 518 is shown at 520. As shown in the illustrated example, user A is computed to have a change of +1, user B is computed to have a change of −1, user C is computed to have a change of +4, and user D is computed to have a change of zero. In the illustrated example, at 522, aggregated attribute module 116 removes from the list of difference values calculated at 518 any users with a change of zero. Thus, as shown in the example result 524, the difference entry for user D is removed from the list. In some aspects, 522 is skipped such that any users with a change of zero are not removed from the list of difference values. However, the remainder of the description of the method of FIGS. 5A through 5E will show nonzero records as removed from the list for consistency of explanation. In some aspects, the removal at 522 can be with regard to a different value than zero. For example, the criteria for removal at 522 can be that the change is less than a threshold value or outside a threshold range.

Now with reference to FIG. 5D, at 526, aggregated attribute module 116 calculates the aggregated attributes relevant to inquiry washing, such as the sum, average, minimum, and maximum values for the list of values representing the change in the counted number of hard inquiries for the noisy identifier. In the illustrated example, as shown at 524, the list includes the values +1, −1, and +4. An example result of the attributes calculation 526 is shown at 528. As shown in the illustrated example, the sum of the change list in 524 is calculated as 1−1+41=4, the average of the list is calculated as (1−1+4)/3=1.333 (to within four significant digits—other precisions are possible in other examples), the maximum of the list is calculated as max(1, −1, 4)=4, and the minimum of the list is calculated as min(1, −1, 4)=−1. At 530, aggregated attribute module 116 returns the calculated aggregated attributes relevant to inquiry washing calculated at 526 for the user identifiers sharing the noisy identifier.

With reference to FIG. 5E, an example table of reported aggregated attribute values relevant to inquiry washing is shown at 532. At 534, aggregated attribute module 116 stores these calculated aggregated attributed values to a data store, illustrated at 536, which can correspond, for example, to data store 118 in FIG. 1.

The above-described process can be repeated, or performed in parallel, to compute aggregated attributes additional to the four shown for the same starting sample, and/or to compute aggregated attributes for a different starting sample. Accordingly, at 538, the aggregated attribute module 116 determines whether the process of computing aggregated attribute values relevant to inquiry washing is done. For example, if all aggregated attributes of interest, relevant to inquiry washing, have been computed (or attempted to be computed) for all user identifiers known in the data store 118, then it can be determined 538 that the process of computing aggregated attribute values relevant to inquiry washing is done and the process can end 540. To periodically refresh the aggregated attribute values relevant to inquiry washing for each user identifier, the process of FIGS. 5A through 5E can be intermittently repeated for all user identifiers, e.g., once every two weeks, once every week, twice per week, once per day, or twice per day.

Based on determining 538 that the process is not done, e.g., that limiting parameters can be adjusted and/or that aggregated attributes relevant to inquiry washing can be computed for more user identifiers, the process can continue, at 542, by adjusting one or more limiting parameters or selecting another sample. For example, to select another sample, a new noisy identifier can be chosen, different from the one used to select the starting sample at 502, and a data store (e.g., data store 118 and/or third-party data store 122) can be searched 506 for user identifiers matching the new noisy identifier. For example, the user identifiers can be processed (e.g., sequentially) until all user identifiers (or a desired fraction of user identifiers) have had all desired aggregated attributes computed for them.

To compute aggregated attributes additional to the four shown at 532 for the same starting sample, limiting parameters can be added or varied in the process illustrated in FIGS. 5A through 5E. Although in the illustrated examples only four aggregated attributes relevant to inquiry washing are computed for each user identifier, a large number of aggregated attributes can be computed, e.g., greater than 100 different aggregated attributes, e.g., greater than 250 different aggregated attributes, e.g., about 300 different aggregated attributes. One limiting parameter that can be adjusted is the time difference between hard inquiry counts, which dictates the past time selected to perform the count at 514. For example, although the illustrated example only shows each of the four aggregated attributes being computed for a single selected past time, the process can be repeated (or performed in parallel) to compute additional aggregated attributes for multiple time differences, e.g., multiple differences between inquiries in the data archive within a current time period and inquiries in the data archive of the past one, three, seven, fifteen, thirty, sixty, ninety, one-hundred eight, or three-hundred sixty-five days, and/or no time difference at all.

Another limiting parameter that can be adjusted is the combination of account type code, KOB code, and/or portfolio type code specified for searching at 510 and 514. The illustrated examples at 512 and 514 show counts of results of a search limited to KOB code “A,” but the counted number of inquiries can be limited to other kinds of inquiries, such as automobile purchase loan inquiries, bank card credit line inquiries, retail card credit line inquiries, collections inquiries, or personal loan inquiries. Thus, although the illustrated example only shows each of the four aggregated attributes being computed for one type of inquiry, the process can be repeated (or performed in parallel) to compute additional aggregated attributes limited to the different loan types of inquiries. This can be done, for example, by limiting the database searches performed at 510 and 514 by adding account type code, KOB code, and/or portfolio type code limitation(s) to the search query, for each desired loan type.

Other aggregated attributes relevant to inquiry washing that can be computed and stored include number of user identifiers for a given noisy identifier with no inquiries, e.g., at present or over any given time period, e.g., over the past one, three, seven, fifteen, thirty, sixty, ninety, one-hundred eighty, and/or three-hundred sixty-five days; number of user identifiers for a given noisy identifier with a decrease in inquiries over any given time period; number of user identifiers for a given noisy identifier with an increase in inquiries over any given time period; and/or number of user identifiers for a given noisy identifier with inquiries, e.g., at present or over any given time period. These aggregated attributes relevant to inquiry washing can be computed and stored for inquiries of all types of loans viewed in the collective, and/or as limited to various particular inquiry loan types (e.g., auto, bank card, collections, personal loan, retail card, or any of the above taken collectively).

Examples of aggregated attributes relevant to inquiry washing include “average number of current hard inquiries for user identifiers sharing the selected noisy identifier (e.g., SSN) with the credit applicant,” “sum of difference in number of current personal loan hard inquiries compared to personal loan hard inquiries from three days prior for user identifiers sharing the selected noisy identifier with the credit applicant,” “minimum difference in number of current bank card hard inquiries compared to bank card hard inquiries from one hundred eighty days prior for user identifiers sharing the selected noisy identifier with the credit applicant,” “maximum number of retail card current hard inquiries for user identifiers sharing the selected noisy identifier with the credit applicant,” “number of user identifiers sharing the selected noisy identifier with the credit applicant having no hard inquiries,” “number of user identifiers sharing the selected noisy identifier with the credit applicant having hard inquiries,” “number of user identifiers sharing the selected noisy identifier with the credit applicant with an increase in personal loan hard inquiries over the past seven days,” “number of user identifiers sharing the selected noisy identifier with the credit applicant with a decrease in retail card hard inquiries over the past sixty days.”

Considering all the timeframe and loan type parameter variations possible in computing aggregated attributes relevant to inquiry washing, the number of computed aggregated attributes relevant to inquiry washing for a given noisy identifier can be large, e.g., about 300. Considering also the number of user identifiers, which can be, e.g., in the hundreds of millions or the billions, the number of aggregated attribute values to be computed and stored by a process such as the one described above with regard to FIGS. 5A through 5E can be large, e.g., in the hundreds of millions, billions, or trillions. Available computing resources (processor cycles, memory, storage, etc.) for performing the above method over all user identifiers in the applicable data store(s) may dictate how much time is required to refresh the aggregated attributes and thus how frequently the refresh process is repeated (e.g., whether it is performed once every two weeks, once every week, twice per week, once per day, or twice per day).

With view again to FIG. 1 or 2, when a client device 104A or 204 makes a request 202 to a data server 110 or 210 for aggregated attributes relevant to inquiry washing for a specified noisy identifier or a specified user identifier, a pre-computed set of aggregated attribute values relevant to inquiry washing for the specified noisy identifier or specified user identifier can be retrieved 218 from the data store 118 and returned 222 to the client device 104A or 204. In the event that aggregated attribute values relevant to inquiry washing have not been computed, or have not been all computed, or have not been recently computed, for the specified noisy identifier or specified user identifier, aggregated attribute module 116 or 216 can be configured to newly compute 218 the requested aggregated attributes and deliver 220 them accordingly, e.g., by using the aggregated attribute computation process described above with regard to FIGS. 5A through 5E.

The following description provides an example functioning of aggregated attributes embodiments when aggregated attributes are used to evaluate the creditworthiness of a credit applicant or credit offer target identifiable as user B in the example of FIG. 5E. A client device 104A or 204 may receive 222 aggregated attributes such as those shown at 522 responsive to a request 206 to the data server 110 or 210 for credit data including aggregated attribute data for a credit applicant or credit offer target identifiable as user B. The client device 104A or 204 may, in some examples, provide as part of its request 206 a noisy identifier (e.g., the SSN) for the credit applicant or credit offer target user B, or, in some examples, the data server 110 or 210 may determine a noisy identifier of the user B based on a search of data stored in data store 118. Provision or determination of a noisy identifier is, however, not necessary where the aggregated attributes 522 have already been computed, e.g., using the process of FIGS. 5A through 5E, at a time prior to the transmission of the request 206. The received 222 aggregated attributes may, in some examples, be limited only to those for a queried credit applicant or credit offer target, such as, in the present example, user B. Accordingly, in the present example, responsive to the request 206, data server 110 or 210 may transmit 222 to the client device 104A or 204 only aggregated attributes for user B, such as sum 4, average 1.333, maximum 4, minimum −1 and/or other aggregated attributes as described above (e.g., about 300 different aggregated attribute values relevant to inquiry washing per user identifier).

Based on receiving these aggregated attribute values, the client device 104A or 204 may determine, for example, that there is a superthreshold risk that the credit record of user B has been subject to inquiry washing, and that the credit record of user B should be subjected to further scrutiny before extending an offer of credit to the credit applicant or credit offer target identified as user B. This may be an appropriate determination even though the aggregated attributes do not in themselves specifically reflect, as shown at 520, that user B in particular has had one past “A” KOB inquiry removed from the consumer credit report of user B. The aggregated attributes relevant to inquiry washing do not reflect this because the aggregated attributes represent an aggregation of data based on a noisy identifier that does not identify user B with full confidence.

The following description now provides an example functioning of aggregated attributes embodiments when aggregated attributes are used to evaluate the creditworthiness of a credit applicant or credit offer target identifiable as user D in the example of FIG. 5E. A client device 104A or 204 may receive 222 aggregated attributes such as those shown at 522 responsive to a request 206 to the data server 110 or 210 for data including aggregated attribute data for a credit applicant or credit offer target identifiable as user D. The client device 104A or 204 may, in some examples, provide as part of its request 206 a noisy identifier (e.g., the SSN) for the credit applicant or credit offer target user D, or, in some examples, the data server 110 or 210 may determine a noisy identifier of the user D based on a search of data stored in data store 118. Provision or determination of a noisy identifier is, however, not necessary where the aggregated attributes 522 have already been computed, e.g., using the process of FIGS. 5A through 5E, prior to the request 206. The received 222 aggregated attributes may, in some examples, be limited only to those for a queried credit applicant or credit offer target, such as, in the present example, user D. Accordingly, in the present example, responsive to the request 206, data server 110 or 210 may transmit 222 to the client device 104A or 204 only aggregated attributes for user D, such as sum 4, average 1.333, maximum 4, minimum −1 and/or other aggregated attributes as described above (e.g., 300 different aggregated attribute values relevant to inquiry washing per user identifier).

Based on receiving these aggregated attribute values, the client device 104A or 204 may determine, for example, that there is a superthreshold risk that the credit record of user D has been subject to credit washing, and that the credit record of user D should be subjected to further scrutiny before extending an offer of credit to the credit applicant or credit offer target identified as user D. This may be the case even though, as shown at 520, user D has not had any “A” KOB inquiries, removed or otherwise, in the consumer credit report of user D during the examined time period reflected in the returned aggregated attribute values. The above description of the process as applied to user D illustrates that, by design of the process, the process can sometimes flag for potential inquiry washing users with no actual inquiry washing in their credit histories. This is because the process relies on aggregated data to determine the aggregated attributes and does not, from the perspective of the client device 104A or 204, directly examine data in a user's credit file to determine a risk of credit washing.

The methods of FIGS. 3, 4A through 4E, and 5A through 5E can be adapted to provide aggregated attributes relevant to forms of credit washing other than tradeline washing and inquiry washing. Similar changes over time can be computed based on a selected noisy identifier to detect the other forms of credit washing, while preserving the privacy and security benefits described above.

### Credit Extension Determination Model Based on Aggregated Attributes

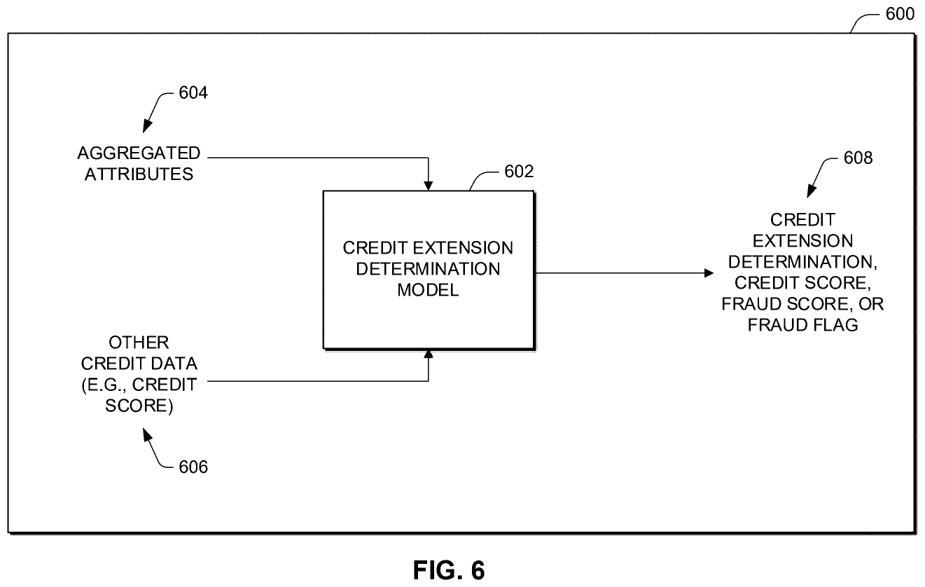

FIG. 6 shows an example credit extension determination model 602, which can be, for example, a scoring model. The credit extension determination model can, as examples, implement one or more statistical methods, rule-based systems, and/or machine-learning (ML) approaches. In some examples, a device 600, such as one or more client devices (e.g., client device 104A) and/or one or more data servers 110, can be configured with a credit extension determination model 602 trained to process input values of aggregated attributes 604, alone or along with other credit data 606, such as a credit score, to provide an output 608. The aggregated attributes 604 can be any combination of the credit washing aggregated attributes described above, such as aggregated attributes relevant to tradeline washing, aggregated attributes relevant to inquiry washing, or a combination thereof. The output 608 can be, as examples, a binary credit extension determination (extend credit/do not extend credit), a numerical credit extension determination (quantifying a maximum amount of credit to extend, as expressed, for example, in currency units), a credit score, a synthetic fraud score, or a fraud flag.

In examples in which the credit extension determination model 602 includes an ML model, the ML model can be trained, for example, with past aggregated attribute data and data indicative of past credit defaults or failures to pay. The ML model can thus be predictive of future credit defaults or failures to pay based on present or future aggregated attribute data. Such a prediction can be used or interpreted as a credit extension determination, e.g., a binary output stating whether credit should be extended or offered to a credit applicant or credit offer target, or a numeric-value output stating a credit limit or maximum loan amount that should be extended or offered to a credit applicant or credit offer target.

In some examples, the ML model of the credit extension determination model 602 can be implemented by defining the architecture of the ML model, transferring training input data to the ML model, training the ML model incrementally, determining the accuracy of the ML model for a specific number of time steps, and applying the trained ML model to process newly-received input data (e.g., aggregated attributes 604 and other credit data 606). The ML model of the credit extension determination model 602 can also, subsequently or contemporaneously, continue to be trained with a given periodicity. The ML model of the credit extension determination model 602 can comprise a support vector machine, a neural network, or any other type of model suitable for supervised learning. For example, a trained neural network model can specify a neural network comprising a neural network topology, a series of activation functions, and connection weights. The topology of a neural network can include a configuration of nodes of the neural network and connections between such nodes. The trained neural network model can also be specified to include other parameters such as bias values or functions and/or aggregation functions. An activation function of a node can be a step function, a sine function, a continuous or piecewise linear function, a sigmoid function, a hyperbolic tangent function, or any other type of mathematical function that can represent a threshold at which the node is activated. An aggregation function can be a function that combines (e.g., via sum, product, etc.) input signals to the node. An output of the aggregation function can be used as input to the activation function. A bias can be a constant value or a function used by the aggregation function and/or the activation function to make a corresponding node more or less likely to be activated. Examples of neural networks can include a recurrent neural network, a long short-term memory neural network, a bidirectional neural network, a multi time scale neural network, and a convolutional neural network.

In other examples, the credit extension determination model 602 includes one or more of a statistical model (implementing, e.g., linear or logistic regression), a rule-based system (e.g., an expert system or a decision tree), an actuarial risk model, or a hybrid model combining one or more of the above.

In examples in which the credit extension determination model 602 is implemented in a data server 110, the output 608 can be transmitted from the data server 110 to a client device 104A (e.g., via network 102) and the receiving client device 104A can subsequently generate a credit offer (or a notice that credit has been declined) as a user output 103 based on the received credit extension determination 608. In other examples, the credit extension determination model 602 can be implemented in the client device 104A, and the client device 104A can subsequently generate a credit offer (or notice that credit has been declined) as user output 103 based on the credit extension determination 608 computed by the client device 104A based on aggregated attributes 604 received from a data server 110 (e.g., via network 102).

### Computer System

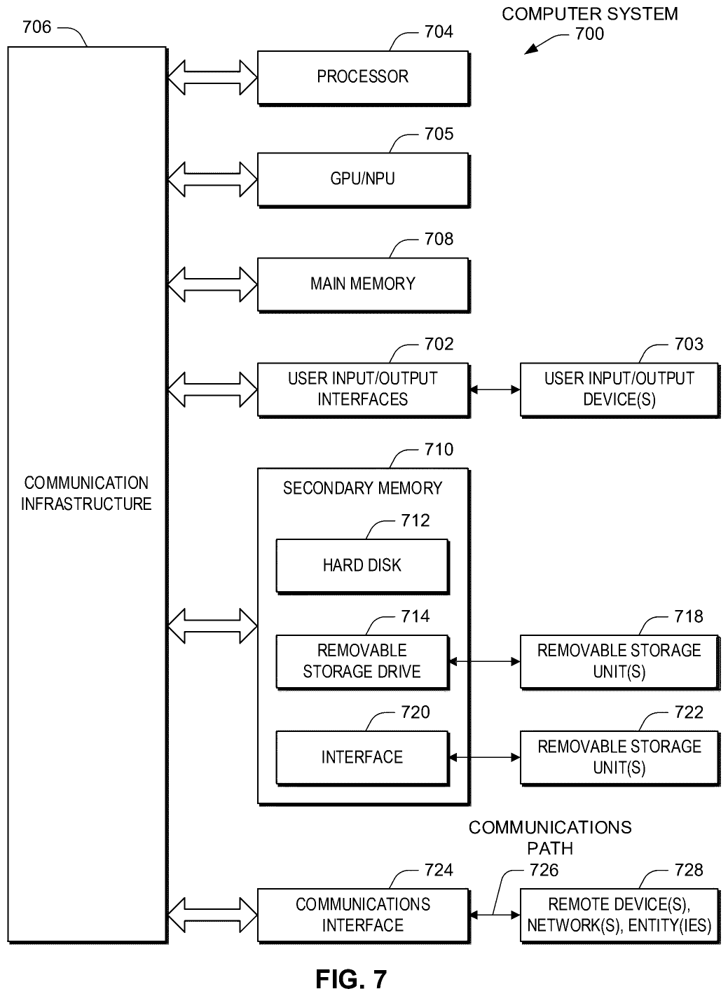

Various embodiments or aspects of embodiments may be implemented, for example, using one or more computer systems, such as computer system 700 shown in FIG. 7. One or more computer systems 700 may be used, for example, to implement any of the embodiments discussed herein, as well as combinations and sub-combinations thereof. For example, one or more computer systems 700 may be used to implement any of client device 104A through 104N or 204, data server 110 or 210, third-party system 120, or devices included in network 102. One or more computer systems 700 may be used to implement device 600. One or more computer systems 700 may be used to implement the methods of FIGS. 4A through 4E and/or FIGS. 5A through 5E.

Computer system 700 can include one or more processors (also called central processing units, or CPUs), such as a processor 704. Processor 704 may be connected to a communication infrastructure or bus 706. Computer system 700 may also include user input/output device(s) 703, such as one or more monitors, keyboards, pointing devices, etc., which may communicate with communication infrastructure 706 through user input/output interface(s) 702.

Computer system 700 can include a graphics processing unit (GPU) and/or neural processing unit (NPU) 705. In various embodiments, a GPU and/or an NPU can be a specialized electronic circuit processor designed to process mathematically intensive applications. The GPU and/or NPU may have a parallel structure that is efficient for parallel processing of large blocks of data, such as mathematically intensive data common to computer graphics applications, images, videos, machine learning or artificial intelligence operations, etc. For example, the GPU and/or NPU 705 may be used for training or inferencing of credit extension determination ML model 602 in FIG. 6.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, a tape backup device, and/or any other storage device or drive. Removable storage drive 714 may interact with a removable storage unit 718. Removable storage unit 718 may include a computer-usable or readable storage device having stored thereon computer software (control logic) and/or data. Removable storage unit 718 may be a floppy disk, magnetic tape, compact disk, DVD, optical storage disk, and/or any other computer data storage device. Removable storage drive 714 may read from and/or write to removable storage unit 718.

Secondary memory 710 may include other means, devices, components, instrumentalities, or other approaches for allowing computer programs and/or other instructions and/or data to be accessed by computer system 700. Such means, devices, components, instrumentalities, or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof) and which may include any combination of LANs, WANs, the internet, etc. Control logic and/or data may be transmitted to and from computer system 700 via communication path 726. Communications path 726 can correspond, for example, to network 102 in FIG. 1.

Computer system 700 may be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (e.g., on-premises cloud-based solutions); “as a service” models (e.g., CaaS, DCaaS, SaaS, MSaaS, PaaS, desktop as a service (DaaS), framework as a service (FaaS), BaaS, MBaaS, IaaS, etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 7. In particular, embodiments can operate with software, hardware, and/or operating system implementations other than those described herein.

The Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes example embodiments for example fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different from those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expressions “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still cooperate or interact with each other.

The breadth and scope of this disclosure should not be limited by any of the above-described exemplary embodiments, but should be defined only in accordance with the following claims and their equivalents.

What is claimed is:

1. A computer-implemented method comprising:
receiving, by at least one computer processor, a noisy identifier that identifies a unique individual or entity represented in a data store with between about seventy-five percent and about ninety percent confidence, wherein the data store comprises records each associated with an individual or entity;
fetching, from the data store, user identifiers each uniquely identifying a corresponding individual or entity represented in the data store, each of the user identifiers associated with the noisy identifier in the data store;
compiling a list of user identifiers and associated record change numbers, the compiling comprising, for each user identifier of the user identifiers:
counting a first number of the records matching one or more specified attribute criteria, each of the first number of the records associated with a first date or first date range, and each of the first number of the records associated with the user identifier;
counting a second number of the records matching the one or more specified attribute criteria, each of the second number of the records associated with a second date or second date range earlier than the first date or first date range, and each of the second number of records associated with the user identifier; and
calculating a record change number for the user identifier by subtracting the second number of the records from the first number of the records;
calculating, as aggregated attributes for each user identifier of the user identifiers, statistical attributes of the record change numbers in the list; and
modifying a report for a selected user identifier of the user identifiers to include the calculated aggregated attributes for the selected user identifier or to include a value or flag derived from the calculated aggregated attributes for the selected user identifier.

2. The computer-implemented method of claim 1, wherein the compiling further comprises, for each user identifier of the user identifiers:
removing from the list the user identifier and its associated record change number based on the record change number being less than a threshold value or outside a threshold range.

3. The computer-implemented method of claim 1, further comprising transmitting the modified report to a client device, wherein the client device is restricted from receiving ones of the record change numbers that are specific to the selected user identifier.

4. The computer-implemented method of claim 1, further comprising repeating the compiling and the calculating aggregated attributes for a third date or third date range different from the second date or second date range and earlier than the first date or first date range, with the third date or third date range substituted for the second date or second date range.

5. The computer-implemented method of claim 1, wherein the one or more specified attribute criteria are first one or more specified attribute criteria, further comprising repeating the compiling and the calculating aggregated attributes for second one or more specified attribute criteria different from the first one or more specified attribute criteria.

6. The computer-implemented method of claim 1, wherein the one or more specified attribute criteria specify records each having at least one of a set of one or more defined account rating profile codes.

7. The computer-implemented method of claim 1, wherein the receiving the noisy identifier comprises selecting the noisy identifier from a set of noisy identifiers stored in a data store.

8. The computer-implemented method of claim 1, further comprising:
receiving a request from a client device, the request including a requested user identifier; and
transmitting to the client device aggregated attribute data comprising a subset of the aggregated attributes corresponding to the requested user identifier, responsive to the request,
wherein the client device is configured to make a determination for the requested user identifier based on the received aggregated attribute data.

9. The computer-implemented method of claim 1, further comprising:
receiving a request from a client device, the request including a requested user identifier;
processing a subset of the aggregated attributes corresponding to the requested user identifier with a machine-learning model to produce an output, wherein the machine-learning model is trained using past aggregated attribute data and data indicative of past user behavior, wherein the output of the machine-learning model comprises a binary determination, a numerical determination, a score, or a flag; and
transmitting the output to the client device responsive to the request,
wherein the client device is configured to make a determination for the requested user identifier based on the received output of the machine-learning model.

10. The computer-implemented method of claim 1, wherein the statistical attributes comprise:
a sum of the record change numbers in the list;
an average of the record change numbers in the list;
a maximum of the record change numbers in the list; and
a minimum of the record change numbers in the list.

11. The computer-implemented method of claim 1, wherein the noisy identifier identifies a unique individual or entity with between about eighty percent and about ninety percent confidence.

12. The computer-implemented method of claim 1, wherein the noisy identifier identifies a unique individual or entity with between about eighty-five percent and about ninety percent confidence.

13. A system, comprising:
a memory; and
at least one processor coupled to the memory and configured to perform operations comprising:
receiving a noisy identifier that identifies a unique individual or entity represented in a data store with between about seventy-five percent and about ninety percent confidence, wherein the data store comprises records each associated with an individual or entity;
fetching, from the data store, user identifiers each uniquely identifying a corresponding individual or entity represented in the data store, each of the user identifiers associated with the noisy identifier in the data store;
compiling a list of user identifiers and associated record change numbers, the compiling comprising, for each user identifier of the user identifiers:
counting a first number of the records matching one or more specified attribute criteria, each of the first number of the records associated with a first date or first date range, and each of the first number of the records associated with the user identifier;
counting a second number of the records matching the one or more specified attribute criteria, each of the second number of the records associated with a second date or second date range earlier than the first date or first date range, and each of the second number of records associated with the user identifier; and
calculating a record change number for the user identifier by subtracting the second number of the records from the first number of the records;
calculating, as aggregated attributes for each user identifier of the user identifiers, statistical attributes of the record change numbers in the list; and
modifying a report for a selected user identifier of the user identifiers to include the calculated aggregated attributes for the selected user identifier or to include a value or flag derived from the calculated aggregated attributes for the selected user identifier.

14. The system of claim 13, wherein the operations further comprise transmitting the modified report to a client device, wherein the client device is restricted from receiving ones of the record change numbers that are specific to the selected user identifier.

15. The system of claim 13, wherein the compiling further comprises, for each user identifier of the user identifiers:
removing from the list the user identifier and its associated record change number based on the record change number being less than a threshold value or outside a threshold range.

16. The system of claim 13, wherein the operations further comprise repeating the compiling and the calculating aggregated attributes for a third date or third date range different from the second date or second date range and earlier than the first date or first date range, with the third date or third date range substituted for the second date or second date range.

17. The system of claim 13, wherein the one or more specified attribute criteria are first one or more specified attribute criteria, and wherein the operations further comprise repeating the compiling and the calculating aggregated attributes for second one or more specified attribute criteria different from the first one or more specified attribute criteria.

18. The system of claim 13, wherein the one or more specified attribute criteria specify records each having at least one of a set of one or more defined account rating profile codes.

19. The system of claim 13, wherein the receiving the noisy identifier comprises selecting the noisy identifier from a set of noisy identifiers stored in a data store.

20. A non-transitory computer-readable medium having instructions stored thereon that, when executed by at least one computing device, cause the at least one computing device to perform operations comprising:
receiving a noisy identifier that identifies a unique individual or entity represented in a data store with between about seventy-five percent and about ninety percent confidence, wherein the data store comprises records each associated with an individual or entity;
fetching, from the data store, user identifiers each uniquely identifying a corresponding individual or entity represented in the data store, each of the user identifiers associated with the noisy identifier in the data store;
compiling a list of user identifiers and associated record change numbers the compiling comprising, for each user identifier of the user identifiers:
counting a first number of the records matching one or more specified attribute criteria, each of the first number of the records associated with a first date or first date range, and each of the first number of the records associated with the user identifier;
counting a second number of the records matching the one or more specified attribute criteria, each of the second number of the records associated with a second date or second date range earlier than the first date or the first date range, and each of the second number of records associated with the user identifier; and
calculating a record change number for the user identifier by subtracting the second number of the records from the first number of the records;
calculating, as aggregated attributes for each user identifier of the user identifiers, statistical attributes of the record change numbers in the list; and
modifying a report for a selected user identifier of the user identifiers to include the calculated aggregated attributes for the selected user identifier or to include a value or flag derived from the calculated aggregated attributes for the selected user identifier.
